(19) United States
(12) Patent Application Publication
(10) Pub. No.: US 2004/0128501 A1
(43) Pub. Date: Jul. 1, 2004

(54) Service offering system for allowing a client having no account to access a managed object with a limited right

(76) Inventors: Yohei Yamamoto, Tokyo (JP); Satosi Imago, Kanagawa (JP); Katsumi Kanasaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/663,781

(22) Filed: Sep. 17, 2003

(30) Foreign Application Priority Data
Sep. 20, 2002 (JP) 2002-274265
Sep. 12, 2003 (JP) 2003-321074
Sep. 12, 2003 (JP) 2003-321075

(51) Int. Cl. H04L 9/00

(52) U.S. Cl. 713/155; 713/184

(57) ABSTRACT

A service offering apparatus can offer various services, which relates to objects such as document data, with a limited right to a client having no account while maintaining security. The service offering apparatus receives an acquisition request for requesting an acquisition of authentication information used for establishing a session having a limited right with respect to the service offering apparatus and the objects. The service offering apparatus transmits the authentication information, and receives a start request for requesting a start of the session containing the authentication information from a client different from an end to which the authentication information is transmitted.

### BACKGROUND OF THE INVENTION

1. Field of the Invention

The present invention generally relates to a service offering apparatus and method and, more particularly, to a service offering apparatus which offers various services with respect to an object to a client.

2. Description of the Related Art

Generally, a document management system, which manages electronic documents, is constituted by a server (document management server) provided with a document data base and a data base management system (DBMS), which manages the document database. The managed object is not limited to a file such as an electronic document, and electronic data (hereinafter, simply referred to as data) is also an object to be managed. A document can be acquired from a document management server by using a client connected to a document management server, especially a client computer (hereinafter, referred to as a client PC) through a network, and there is a case where one wants to print out the document by a printer of another client connected to the client PC or a case where one wants to transmit the document to other PCs connected the client PC. In any case, basically, the client PC transmits the document (including a case of print data), which the client PC acquired from the document management server, to other PCs or printers. An above-mentioned network is the network, which connects the document management server to the printer (or the print server thereof), and if the Internet technology is used, the client PC may use a technique referred to as Web printing in which the client PC sends a print request to a remote printer through a server. This technology can be used in other networks, which are not the Internet.

On the other hand, a document management server, which manages documents by setting an access right to documents stored in a document database so as to consider a security function as important among the functions of the document management, is suggested in various forms.

Although the document management server, which set up the access right, controls access to each document according to user information (information regarding a user ID, a password, etc.) for each user, it may be necessary to transmit a document to a client (PC, printer, etc.), which is different from a client PC used by a user and designated by the user. In such as case there is a document exchange system as an effective method using a document ticket. By using the document ticket, a document can be transmitted to other clients without routing a user client. For example, conventionally, there is suggested a file printing method in which contents of a document system can be acquired using a certificate (document ticket) for the right to access a document and temporarily giving the access right for the document to a client having no general right with respect to the document management system (for example, refer to Japanese Patent Publication No. 3218017).

FIG. 1 is an illustration for explaining a process for using a document ticket according to a conventional technique, and also explaining a file printing method using a document ticket.

This file printing method is a method of printing a file, which exists in a document management system (provided with a document management server (file server)) 101 through the Internet, and comprises: a step (i) of requesting a right to print a file from a first computer (client A (102)) to a document management server (101); a step (ii) of issuing, in response to the request, a certificate including information transmitted to a client B (103)) from the document management server (101) to the client A (102), the information including an Internet address of the client A (102) and needed for the print server (client B (103)) so as to request the file; a step (iii) of sending the certificate from the client A (102) to the client B (103); a step (iv) of sending a message including the certificate, as a right to request and receive the file-, from the client (B) to the document management server (101), and is received from Client B (103); and a step (v) of sending the file from the document management server (101) to the client B (103) after confirming from the contents of the certificate that the certificate is the same certificate as the certificate having been issued to the client A (102).

That is, in this file printing method, first, the client A (102) of the document management server (101) designates a document x which the client A (102) has an access right, and acquires a document ticket y from the document management server (document management system) (101). This document ticket y is for transferring the access right for the document x to another client (here, the client B). The client A (102) passes the acquired document ticket y to the client B (103). Next, the client B (103) issues a request for acquiring the contents of the document x to the document management system (101) using the document ticket y received from the client A (102). The document management system (101) checks that the document ticket y which the client B (103) presented is the ticket which surely was issued to the client A (102), and returns directly the document x which the client B (103) is requesting without passing through the client A (102). The client B (103) becomes possible to print the document x by the printer (104) connected thereto. Supposing, for example, the client B (103) requests not the document x but a document x′, the document management system (101) can determine that the client B (103) does not have the access right by comparing the document ticket y with the requested document x′.

Thus, the client B (103) can access the document management system (101) so as to acquire the contents of the document by being given the right with respect to a limited document as a document ticket from the client A (102) even if the client B (103) does not have a direct access right to the document management system (101).

In a usual document management system, a client can perform not only an acquisition of contents of a document but also various processes such as an acquisition of a document property, an acquisition of an old version, an acquisition of information regarding an access right for each document management function. However, as mentioned above, in the conventional document ticket system, process which can be performed using the document ticket is basically only the acquisition of contents of a document. Thus, a client having no account of the document management system cannot perform those operations for each document management function while maintaining security. It should be noted that also the conventional document ticket system can perform a process other than the acquisition of contents of a document. However, it is necessary to introduce a method (function), which is exclusive for the document management system, into a process permitted by the document, such as for example a method for acquiring a document property including a document ticket as an argument if a case of acquiring the document property or a method for acquiring an old version including a document ticket as an argument in a case of acquiring the old version.

### SUMMARY OF THE INVENTION

It is a general object to provide an improved and useful service offering apparatus in which the above-mentioned problems are eliminated.

A more specific object of the present invention is to provide a service offering apparatus and method which can offer various services, which relates to objects such as document data, with a limited right to a client having no account while maintaining security.

In order to achieve the above-mentioned objects, there is provided according to one aspect of the present invention a service offering apparatus for offering services associated with objects that comprises: authentication information acquisition request receiving means for receiving an acquisition request for requesting an acquisition of authentication information used for establishing a session having a limited right with respect to the service offering apparatus and the objects; authentication information transmitting means for transmitting the authentication information; and session start request receiving means for receiving a start request for requesting a start of the session containing the authentication information from a client different from an end to which the authentication information is transmitted.

According to the above-mentioned invention, a client having no account with the service offering apparatus such as a server can acquire the authentication information from a client having an account with the service offering apparatus. Thus, various services can be offered to the client having no account within a limited right while maintaining a security.

It should be noted that, in one embodiment of the present invention which is associated with a document management system, the authentication information corresponds to a document ticket or a part of a document ticket and the objects correspond to documents managed by a document management server.

In the service offering apparatus according to the present invention, the acquisition request of the authentication request may contain a list of object identifiers for identifying the objects and a list of service identifiers for identifying services associated with the objects. The service offering apparatus according to the present invention may further comprise authentication information producing means for producing the authentication information in response to the acquisition request of the authentication information. Additionally, the service offering apparatus may further comprise authentication information managing means for managing the authentication information.

In the service offering apparatus according to the present invention, the authentication information managing means may manage the authentication information by relating with the list of the object identifiers for identifying the objects and the list of the service identifiers for identifying the services associated with the objects. Additionally, the service offering apparatus may further comprise session producing means for producing the session in response to the start request of the session. Further, the service offering apparatus may further comprise session managing means for managing the session.

In the service offering apparatus according to the present invention, the session managing means may manage the session by relating with the authentication information. The service offering apparatus may further comprise session identifier transmitting means for transmitting a session identifier for identifying the session to the client. Additionally, the service offering apparatus may further comprise use request receiving means for receiving a use request for requesting a use of a service associated with the objects from the client, the use request including a session identifier for identifying the session. Further, the service offering apparatus may further comprise service offering means for offering a service associated with the objects in response to a use request for requesting a use of a service associated with the objects from the client, the use request including a session identifier for identifying the session. In the service offering apparatus according to the present invention, the service associated with the objects which is offered in the session may be designated.

Additionally, there is provided according to another aspect of the present invention a service offering apparatus for offering services associated with objects that comprises: session start request receiving means for receiving a start request for requesting a start of a session with the service offering apparatus; session identifier transmitting means for transmitting a session identifier for identifying the session; and use request receiving means for receiving a use request for requesting a use of a service associated with the objects from a client different from an end to which the session identifier is transmitted, the use request including information regarding the session identifier.

According to the above-mentioned invention, a client having no account with the service offering apparatus such as a server can acquire the session identifier (session ID) from a client having an account with the service offering apparatus. Thus, various services can be offered to the client having no account within a limited right while maintaining a security.

The service offering apparatus according to the present invention may further comprise session producing means for producing the session in response to the start request of the session. The service offering apparatus mat further comprise session managing means for managing the session. Additionally, the service offering apparatus may further comprise service offering means for offering the service associated with the objects in response to use request of the service associated with the objects, the use request containing the information regarding the session identifier.

In The service offering apparatus according to the present invention, the information regarding the session identifier may include the session identifier and an object identifier for identifying the objects. Additionally, the information regarding the session identifier may includes the session identifier and a service identifier for identifying a service associated with the objects. The information regarding the session identifier may be encrypted by a public key.

The service offering apparatus may further comprise public key providing means for providing a public key in response to an acquisition request for requesting an acquisition of the public key. In the service offering apparatus, the information regarding the session identifier may be encrypted by a common key common to the service offering apparatus.

The service offering apparatus according to the present invention may further comprise session identifier processing means for processing the session identifier. Additionally, the service offering apparatus may further comprise encrypting means for encrypting the session identifier processed by the session identifier processing means.

The above-mentioned invention can be achieved in the form of a service offering method. Additionally, service offering method according to the present invention can be performed by a computer by providing a service offering program which describes the service offering program. The service offering program may be stored in a processor readable medium so that a computer is caused to execute the service offering program by reading the processor readable medium.

Other objects, features and advantages of the present invention will become more apparent from the following detailed descriptions when read in conjunction with the accompanying drawings.

### BRIEF DESCRIPTION OF THE DRAWINGS

FIG. 1 is an illustration for explaining a process for using a document ticket according to a conventional technique, and also explaining a file printing method using a document ticket;

FIG. 2 is an illustration for explaining a document offering system according to a first embodiment of the present invention;

FIG. 3 is an illustration showing a structure of a document management server shown in FIG. 2;

FIG. 4 is a flowchart for explaining a process procedure of a session start according to a document ticket;

FIG. 5 is a flowchart for explaining a document property offering procedure according to a session started by a document ticket;

FIG. 6 is a flowchart for explaining a document contents offering procedure according to a session which has been started using a document ticket;

FIG. 7 is an illustration showing a management table representing services which can be offered in a session started using a document ticket;

FIG. 8 is a flowchart for explaining a document property offering procedure according to a session which has been started using a document ticket in a service offering method according a variation of the first embodiment of the present invention;

FIG. 9 is a flowchart for explaining a document contents offering procedure according to a session which has been started using a document ticket in a service offering method according to another variation of the first embodiment of the present invention;

FIG. 10 is a flowchart for explaining a process procedure for registering a method usable at a time of acquiring a document ticket in a service offering method according to another variation of the first embodiment of the present invention;

FIG. 11 is an illustration showing an example of methods which can be performed with a document ticket;

FIG. 12 is a flowchart for explaining a document property offering procedure according to a session started using a document ticket in a service offering method according to anther variation of the first embodiment of the present invention;

FIG. 13 is a flowchart for explaining a process procedure for discarding an old ticket when starting a session according to a document ticket in a service offering method according a variation of the first embodiment of the present invention;

FIG. 14 is a block diagram of a hardware structure of a general CS system to which a document management server according to the present invention is applied;

FIG. 15 is an illustration for explaining a process for starting a session between a document management server and a client;

FIG. 16 is an illustration for explaining a method of acquiring contents of a document;

FIG. 17 is an illustration for explaining a process associated with an acquisition of contents of a document using a processed session ID;

FIG. 18 is an illustration for explaining a processed session ID;

FIG. 19 is a functional block diagram of an example of the document management server shown in FIG. 17;

FIG. 20 is a flowchart for explaining a process associated with a document contents acquisition using a session ID′ in the document management server;

FIG. 21 is an illustration for explaining another example of the process associated with acquisition of the contents of a document using a processed session ID;

FIG. 22 is an illustration for explaining a processed session ID;

FIG. 23 is a flowchart for explaining a process associated with acquisition of the contents of a document using the session ID′ in the document management server;

FIG. 24 is an illustration for explaining another example of the process associated with acquisition of the contents of a document using a processed session ID;

FIG. 25 is a functional block diagram of an example of the document management server shown in FIG. 24;

FIG. 26 is a flowchart for explaining another example of the process associated with a document contents acquisition using a session ID′ in the document management server;

FIG. 27 is an illustration for explaining another example of the process associated with acquisition of the contents of a document using a processed session ID;

FIG. 28 is a functional block diagram of an example of the document management server shown in FIG. 27;

FIG. 29 is an illustration for explaining another example of the process associated with acquisition of the contents of a document using a processed session ID;

FIG. 30 is a functional block diagram of an example of the document management server shown in FIG. 29;

FIG. 31 is a flowchart for explaining a process associated with processing of the session ID in the document management server shown in FIG. 29;

FIG. 32 is an illustration for explaining an example of a method of acquiring the processed session ID;

FIG. 33 is an illustration for explaining another example of the process associated with acquisition of the contents of a document using a processed session ID;

FIG. 34 is a functional block diagram of an example of the document management server shown in FIG. 33;

FIG. 35 is a flowchart for explaining a process associated with processing of the session ID in the document management server shown in FIG. 33;

FIG. 36 is an illustration for explaining the session ID′;

FIG. 37 is an illustration for explaining a process of acquiring attribute information of a document using a processed session ID; and

FIG. 38 is a flowchart for explaining an example of the process associated with a document attribute information acquisition using a processed session ID in the document management server.

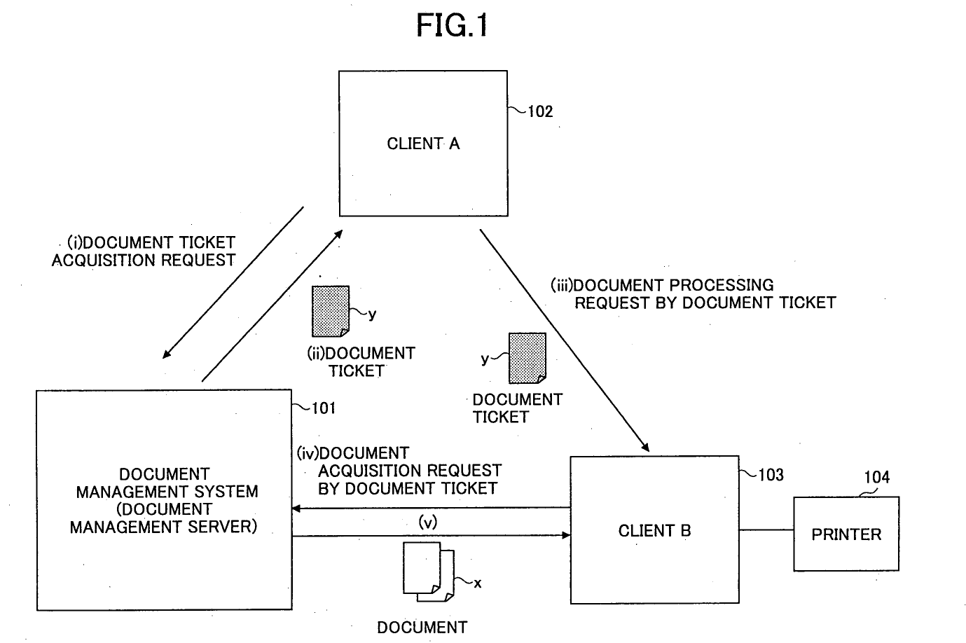

### DETAILED DESCRIPTION OF THE PREFERRED EMBODIMENTS

A description will now be given, with reference to the drawings, of embodiments of the present invention. It should be noted that descriptions will be given below of various embodiments and variations thereof with an electronic document (may be simply referred to as a document) as an example from among electronic files which are especially effective for applying the present invention. However, the present invention is applicable not only to data referred to as “electronic document” but also to data having a plurality of processes which can be performed such as acquisition of contents, printing, acquisition of property, etc.

(First Embodiment)

A description will now be given of a first embodiment of the present invention.

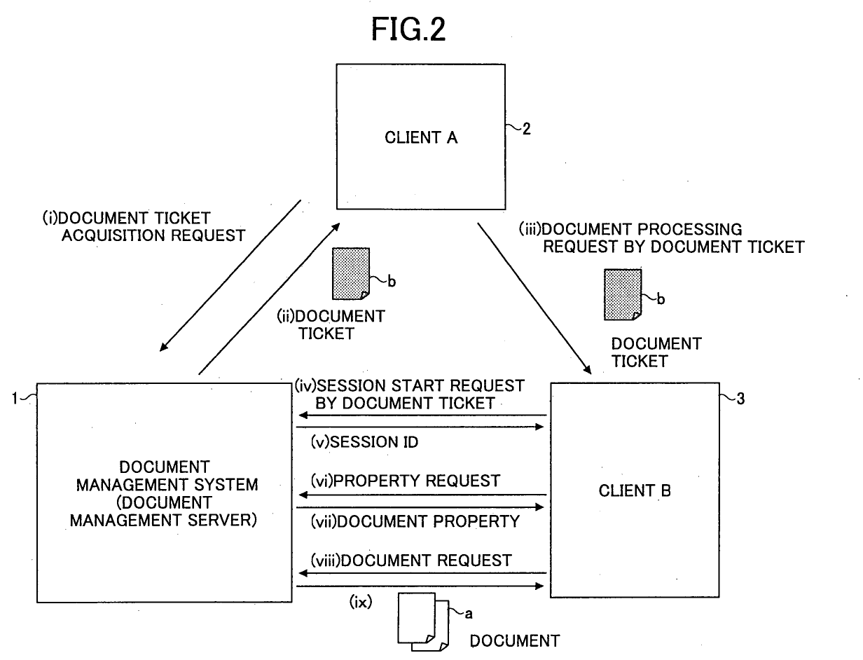

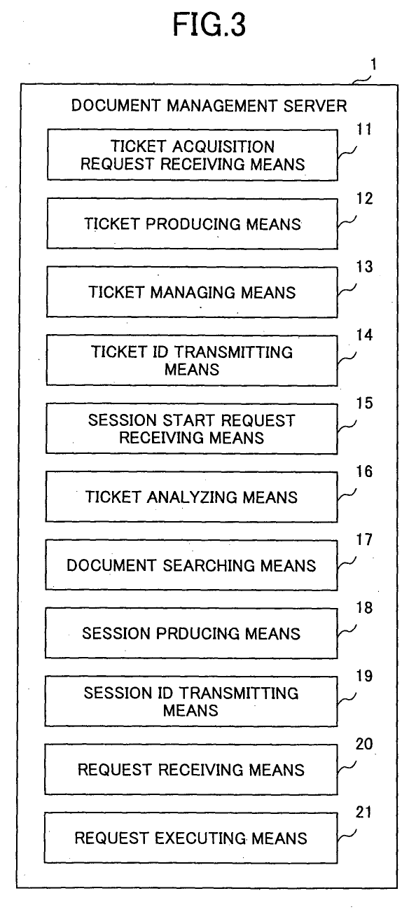

FIG. 2 is an illustration for explaining a document offering system according to a first embodiment of the present invention. FIG. 3 is an illustration showing a structure of a document management server shown in FIG. 2.

A service offering method according to the first embodiment of the present invention starts a session with a document management server 1 using a document ticket. It should be noted that a description of a service offering program which executes the service offering method and a description of a recording medium storing the service offering program are basically substituted by the description of the service offering method and the document management server 1.

The document management server 1 which is exemplified here is constituted as a server of a general server-client system through a network. The document management server is connected with a client A (2) as one of clients and a client B (3) as one of other clients having no account of the document management server 1 through the network.

It should be noted that the service offering apparatus according to the present invention is applicable to an image forming apparatus. In such a case, for example in FIG. 2, an image forming apparatus plays a roll of a part corresponding to the document management server 1, and operates a document image stored in a memory device of an image forming apparatus such as a multi-function printer (MFP) according to a document ticket. At this time, an image forming apparatus can be seen from a client as a document management server 1 (in this case, it can be the also as an image data server). Even if the client B (3) has an account of the document management server 1, the present invention is applicable if the client B (3) does not have an access right to a predetermined document, and a process regarding the predetermined document associated with a document ticket by starting a session with the document management server 1 using the document ticket.

It should be noted that it is preferable to strengthen the security of a network so that a document ticket may not be altered or may not be acquired by other users. As for a network, network systems such as the Internet, the Intranet or the Extranet using a telephone line or a communication line (not limited to cable or radio). The network systems are not limited to a LAN environment, and may be built in the WAN environment or the MAN environment depending on the locations where the server is installed.

Moreover, in order to strengthen security further, the document management server 1 may encipher the document ticket or a part of the document ticket or a ticket ID mentioned later, and may send the enciphered data to a client. Moreover, although it is explained that the document management server 1 and each of the client A (2) and the client B (3) are connected to each other through the network, the document management server 1 and the client A (2) or the client B (3), or the client A (2) and the client B (3), or the document management server 1 and the client A (2) and the client B (3) may be in the same apparatus (server). It should be noted that a description will be given below, for the sake of simplification of explanation, on the assumption that the document management server 1, the client A (2) and client B. (3) are connected mutually through a network.

A description will now be given, with reference to FIG. 3, of the structure of the document management server 1. As shown in FIG. 3, the document management server 1 comprises ticket acquisition request receiving means 11, ticket producing means 12, ticket managing means 13, ticket ID transmitting means 14, session start request receiving means 15, ticket analyzing means 16, document searching means 17, session producing means 18, session managing means 19, session ID transmitting means 20, request receiving means 21, and request executing means 22. It should be noted that, in addition to the means 11-22, the document management server 1 is provided with various service offering means which are processes (or methods) requested by the request executing means 22. Brief descriptions will be given below of each of the means 11-22. However, descriptions of each process in the service offering method mentioned later may be referred to for details and other modes of each of the means 11-22.

The ticket acquisition request receiving means 11 receives an acquisition request of the document ticket from the client A (2). It should be noted that, as mentioned later, a list of document identifiers which identify documents and service identifiers which identifies the services (for example, acquisition of document property, acquisition of the contents of a document, etc.) associated with the documents.

The ticket producing means 12 produces a document ticket in response to the acquisition request of the document ticket received by the ticket acquisition request receiving means 11. It should be noted that the ticket document includes a ticket ID, a user account (for example, user account of the user of the client A (2)), a list of documents IDs which can be used by the document ticket, a list of document names, and an effective term of the document ticket concerned, in accordance with their forms. Moreover, the ticket document may include use client limitation information according to each client or use client limitation information according to each kind of client. The use client limitation information according to each client represents, for example, that the ticket is for clients C and D, and cannot be used for the client B. The use client limitation information according to each kind represents, for example, that the ticket cannot be used when a client is a PC and can be used when a client is a printer. The ticket managing means 13 manages the document ticket produced in the ticket producing means 12. It should be noted that, as mentioned later, the ticket managing means 13 manages the document tickets by relating with the service identifiers or service name, which identifies the services (for example, acquisition of document property, acquisition of the contents of a document, etc.) concerning the documents which can be used with the document tickets. The ticket ID transmitting means 14 transmits to the client A (2) the ticket ID included in the document ticket as a document ticket. Instead of the ticket ID, the document ticket itself may be transmitted to the client A (2), or a part of the document ticket may be transmitted to the client A (2).

The session start request receiving means 15 receives a start request of the session containing some of document tickets from client B (3), document tickets, or Ticket ID. The ticket analyzing means 16 analyzes a corresponding document ticket based on the document ticket, a part of the document ticket or the ticket ID, which is contained in the session start request received by the session start request receiving means 15. For example, the ticket analyzing means 16 analyzes, with reference to the ticket managing means 13, as to whether or not the document ticket, a part of the document ticket or the ticket ID, which is received by the session start request receiving means 15, is effective. The document searching means 17 searches for a document corresponding to the document ticket so as to check whether or not the document is present. It should be noted that the documents may be stored in the document management server 1 or may be stored in an apparatus (server) other than the document management server 1. However, a description will be given below on the assumption that the documents are stored in the document management server 1 for the sake of simplification of explanation.

The session producing means 18 produces a new session in response to a session start request. The session concerned contains a session ID and a term of validity of the session ID. Moreover, the corresponding ticket ID or document ticket may be contained in the session, or a list of document IDs contained in the corresponding document ticket may be included.

The session managing means 19 manages the session produced by the session producing means 18. The session ID transmitting means 20 transmits to client B (3) the session ID, which identifies the session produced by the session producing means 18.

The request receiving means 21 receives a request of a process (or method) containing the session ID from the client B (3). The request executing means 22 performs the request received from the client B (3) (causes a corresponding means to perform the requested service offering process).

The “request” mentioned here may contain the various requests such as: a request for document property; a request for a document (a request for contents of a document; a request for a document as print data especially when the client B is a printer or a print server); and a request for one or more documents in a predetermined version (change history) or a combined document, and not only one of the requests but also a plurality of requests may be made. Actually, in the present invention, it is possible to start a session with the document management server 1 according to a document ticket, and a plurality of requests can be handled in the started session according to the single document ticket.

Therefore, according to the present invention, a document can be acquired by a single document ticket (when ending a session between processes, a new document ticket produced from the document ticket is also used), and the contents thereof can be changed and registered in the document management server 1. Moreover, acquisition of a combined document which consists of document files I, II and III can be performed on one or more document files according to a single document ticket. When acquiring the three document files, each individual document file may be acquired by a method “getDocContent (I)” after acquiring a file list using a method “getDocElementlist( )”.

In the service offering method according to the present embodiment, first, the client A (2) accesses a document a of the document management server 1 based on a request of a user, and makes an acquisition request for a document ticket b having an access right to the document a (step i). Upon the request from the client A (2), the document management server 1 produces a document ticket b after checking whether the user of the client A (2) has an access right to the requested document a, and returns to the client A (2) the document ticket b having the access right to the document a (step ii).

The client A (2) passes the document ticket b returned from the document management server 1 to another client B (3) which can trust, and commands a process to the document by designating items to be processed (step iii). Here, a description will be given on the assumption that the client B (3) is a printer and the client A (2) requests the client B (3) printing of the document.

The client B (3), which received the printing request from the client A (2) according to the document ticket b, passes the receive document ticket b to the document management server 1, and requests a start of a session having a limited right and using the document ticket b (step iv). The document management server 1, which received the session start request by the document ticket b from the client B (3), confirms that the document ticket b is produced based on the request made by the client A (2), and produces a session and returns a session ID (step v). Thus, the fact that the session ID in response to the session start request according to the document ticket indicates that the client B (3) is given a right (limited), that is, the client B (3) has a tentative account. A description will now be given in detail of the process of the step v.

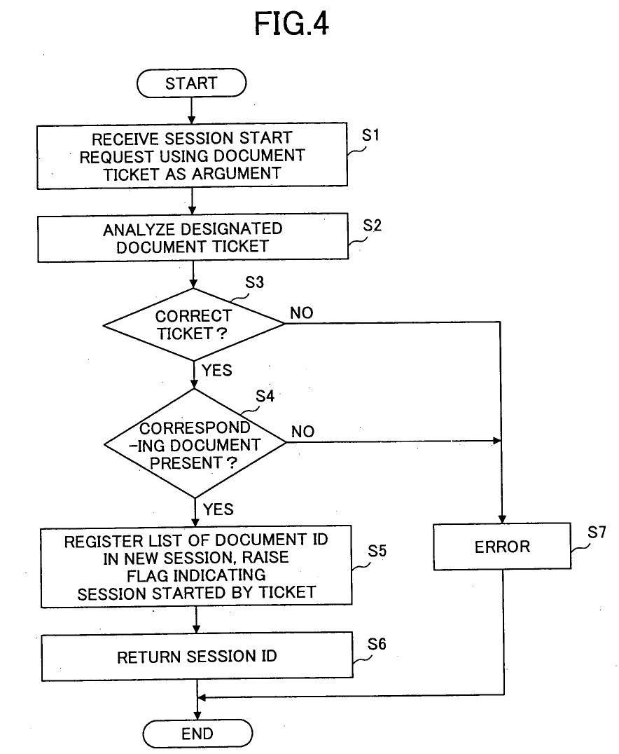

FIG. 4 is a flowchart for explaining a process procedure of a session start according to a document ticket.

In the process of the session start according to the document ticket b in the document management server 1, first, a session start request is received (step S1) by using a document ticket as an argument, and the designated document ticket is analyzed (step S2). Next, it is determined (step S3) whether or not the document ticket is correct, and if not a correct ticket, an error is output (step S7). On the other hand, if it is a correct ticket, it is determined (step S4) whether or not there is a document concerned. If there is no correct ticket, the routine proceeds to step S7. If there is a correct ticket, the routine proceeds to step S5. In step S5, a new session is produced and a list of document IDs is registered in the session, and a flag indicating that the session is started according to the ticket is raised. Here, the flag, which is necessary for starting the session using the ticket as an argument and shows that it is the session which is started according to the ticket, is raised. It should be noted that the flag may take values, such as “0” or “1”, and may be the ticket ID or the document ticket itself. Finally, the session ID is returned to the client B (3) (step S6). The session ID may be random.

Subsequent to step v, the client B (3) inquires the document management server 1 about the list of document IDs contained in the document ticket b, and the document management server 1 answers to the client B (3) with the list of document IDs contained in the session (or document ticket) corresponding to the session ID.

Next, the client B (3) makes an acquisition request for the document property using the received session ID and the document ID contained in the document ID list (step vi). The document property contains information regarding a document name, a producer, etc. Moreover, although there is a mode in which the user of the client A (2) instructs the client B (3) to perform the document processing by also designating the request, there may be a mode in which the user of the client B (3) makes the request. The document management server 1 checks whether or not the document ID requested by the client B (3) is contained in the session (or document ticket) corresponding to the session ID. If the document ID is contained, the document management server 1 returns the document property (step vii). If the property of the document ID which is not contained in the session (or document ticket) corresponding to the session ID is requested, it is determined as an unauthorized access and an error process is performed.

A description will now be given in detail of the process of step vii.

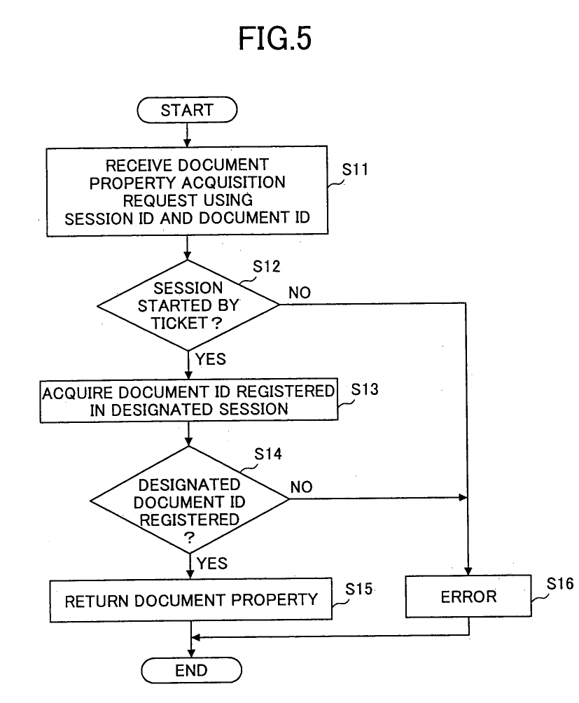

FIG. 5 is a flowchart for explaining a document property offering procedure according to a session started by a document ticket.

In the process of acquiring the document property in the session started by the document ticket in the document management server 1, a document property acquisition request is first accepted by setting as arguments the session ID of the session started by the document ticket and the document ID of the document of which property is to be acquired (step S11). Next, it is determined (step S12) whether or not the session has been started using the document ticket b. If the session is not a session started using the document ticket b, error information is output (step S16). If the session is a session started using the document ticket b, a document ID registered for the designated session is acquired (step S13). Next, it is determined whether or not the designated document ID has been registered for the session (step S14). If not registered, the routine proceeds to step S16. If registered, the document property is returned to the client B (3) (step S15). Thus, in the document management server 1, it is determined first whether the session concerned is a session which has been started using the document ticket b. If the determination is affirmative, it is then determined whether the designated document ID is registered for the session.

Subsequent to step vii, similar to the case of the document property, the client B (3) passes a document contents acquisition request to the document management server 1 by using the session ID and the document ID. The document management server 1 checks whether or not the document ID requested by the client B (3) is an authorized one usable in the session, and return the contents of the document or error information (step ix).

A description will be given in detail of the process of step ix.

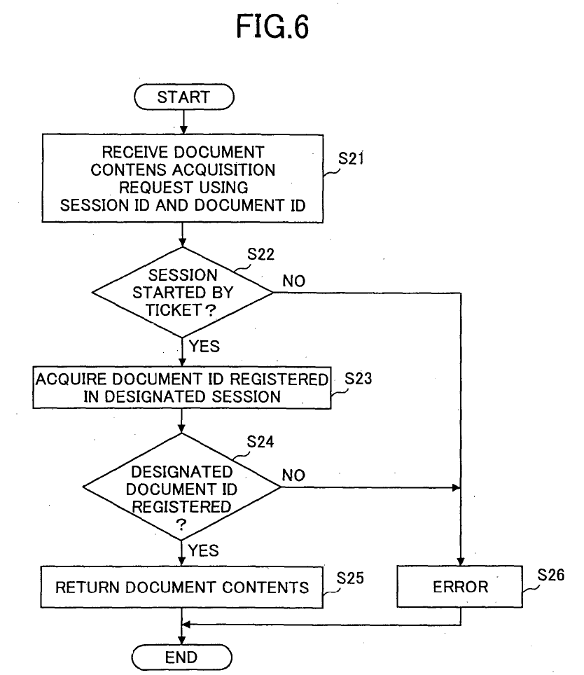

FIG. 6 is a flowchart for explaining a document contents offering procedure according to a session which has been started using a document ticket.

In the process of acquiring the contents of a document according the session started by the document ticket in the document management server 1, a document contents acquisition request is first accepted by setting as arguments the session ID of the session started by the document ticket and the document ID of the document of which contents is to be acquired (step S21). Next, it is determined (step S22) whether or not the session has been started using the document ticket b. If the session is not a session started using the document ticket b, error information is output (step S26). If the session is a session started using the document ticket b, a document ID registered in the designated session is acquired (step S23). Next, it is determined whether or not the designated document ID has been registered for the session (step S24). If not registered, the routine proceeds to step S26. If registered, the document property is returned to the client B (3) (step S25). Thus, in the document management server 1, it is determined first whether the session concerned is a session which has been started using the document ticket. If the determination is affirmative, it is then determined whether the designated document ID is registered for the session.

Subsequent to step ix, the client B (3) performs the process (for example, printing) requested by the client A (2) using the acquired property and the contents of the document.

It should be noted that although the example was shown in which the client B (3) performs the acquisition of the document property and the acquisition of the contents of the document, such a process or other processes may be performed using the session ID which identifies the session applied by the client B (3) using the document ticket.

According to the present embodiment, services associated with various documents can be offered without need of a direct access right to the document management server 1. Moreover, in the above-mentioned example, the authentication information of the client A (2) is not given to the client B (3) since it is a process according to a document ticket.

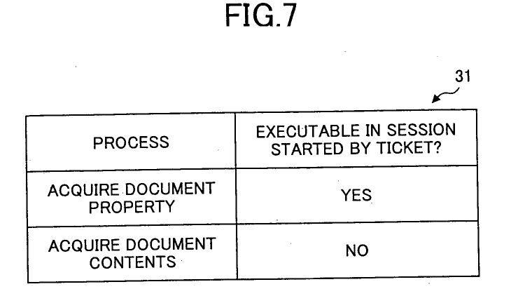

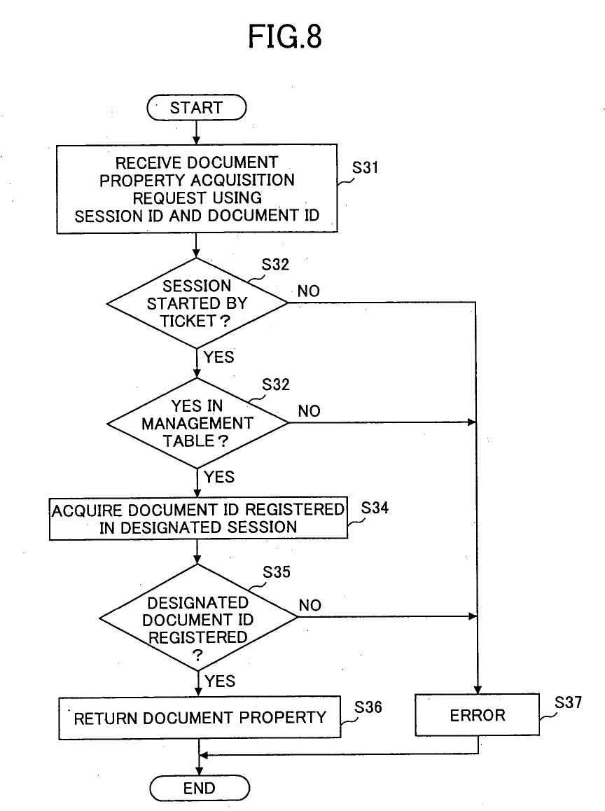

FIG. 7 is an illustration showing a management table representing services which can be offered in the session started using a document ticket. FIG. 8 is a flowchart for explaining a document property offering procedure according to a session which has been started using a document ticket in a service offering method according a variation of the first embodiment of the present invention.

The service offering method according to the variation of the first embodiment of the present invention may limits the services usable in the session which has been started using a document ticket in the service offering method explained with reference to FIGS. 2 through 6.

A description will now be given, with reference to FIGS. 7 and 8, of a case for setting to a session, which is started using a document ticket, that the acquisition of the document property can be performed but the acquisition of contents of a document cannot be performed. The management table, which manages the limitation, is represented as a management table 31 shown in FIG. 7. In the management table 31 illustrated as an example, the acquisition of document property shall be permitted in the session started using the document ticket, and the acquisition of contents of a document shall not be permitted in the session started using the document ticket.

In the process of acquiring the document property in the session started by the document ticket in the document management server 1, a document property acquisition request is first accepted by setting as arguments the session ID of the session started by the document ticket and the document ID of the document of which property is to be acquired (step S31). Next, it is determined (step S32) whether or not the session has been started using the document ticket b. If the session is not a session started using the document ticket b, error information is output (step S37). If the session is a session started using the document ticket b, it is determined (step S33) whether or not the process is set to be executable in the management table 31. If the process is not set to be executable, the routine proceeds to step 37. If the process is set to be executable, the document ID registered for the designated session is acquired (step S34). Next, it is determined (step S35) whether or not the designated document ID has been registered for the session. If not registered, the routine proceeds to step S37. If registered, the document property is returned to the client B (3) (step S36). Here, according to the management table 31, the acquisition of the document property is performed since the acquisition of the document property is permitted for the session which is started using the document ticket. It should be noted that the management table 31 is managed by, fro example, the session managing means 19.

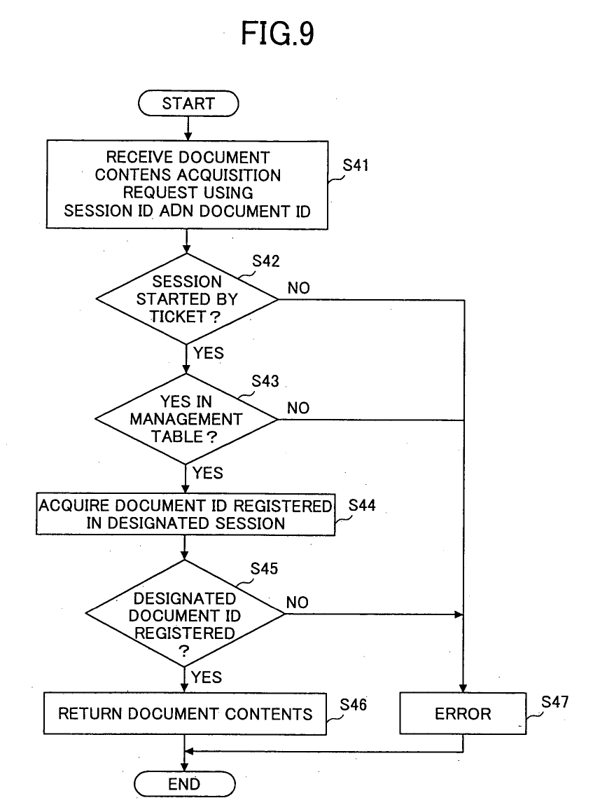

FIG. 9 is a flowchart for explaining a document contents offering procedure according to a session which has been started using a document ticket in a service offering method according to another variation of the first embodiment of the present invention.

A description will now be given, with reference to FIGS. 7 and 9, of a case for setting to a session, which is started using a document ticket, that the acquisition of the document property can be performed but the acquisition of contents of a document cannot be performed. The management table, which manages the limitation, is the management table 31 shown in FIG. 7.

In the process of acquiring the contents of a document according the session started by the document ticket in the document management server 1, a document contents acquisition request is first accepted by setting as arguments the session ID of the session started by the document ticket and the document ID of the document of which contents is to be acquired (step S41). Next, it is determined (step S42) whether or not the session has been started using the document ticket b. If the session is not a session started using the document ticket b, error information is output (step S47). If the session is a session started using the document ticket b, it is determined (step S43) whether or not the process is set to be executable in the management table 31. If the process is not set to be executable, the routine proceeds to step 47. If the process is se to be executable, the document ID registered for the designated session is acquired (step S44). Next, it is determined whether or not the designated document ID has been registered for the session (step S45). If not registered, the routine proceeds to step S47. If registered, the document property is returned to the client B (3) (step S46). Here, according to the management table 31, error information is output with respect to the acquisition of the contents of the document since the acquisition of the contents of the document is not permitted for the session which is started using the document ticket.

According to the present variation, services associated with various documents can be offered without need of a direct access right to the document management server 1, and, in addition, the access right to the document management server 1 can be controlled, thereby maintaining security of the system.

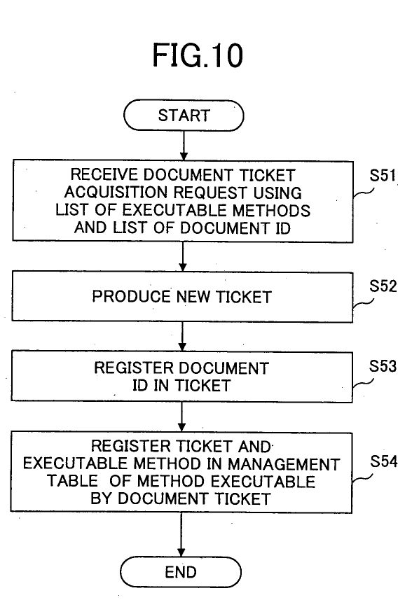

FIG. 10 is a flowchart for explaining a process procedure for registering a method usable at a time of acquiring a document ticket in a service offering method according to another variation of the first embodiment of the present invention.

The service offering method according to another variation of the first embodiment of the present invention may be set so that when acquiring a document ticket in the service offering method mentioned with reference to FIG. 7 through FIG. 9, limitation of usable services can be designated in the session, which can be started by the document ticket. The process explained with reference to FIG. 10 corresponds to the process of step ii of FIG. 2.

In the document ticket acquisition process in the document management server 1, a document ticket acquisition request is first received from the client A (2) by setting as arguments a list of document IDs and a list of methods which can be performed (step S51). Next, a new ticket is produced (step S52), and the document ID is registered in the new ticket (step S53). Finally, the ticket ID and the method which can be performed are registered in a management table of methods which can be performed with a document ticket (step S54). Thus, in the document management server 1, a new document ticket is acquired by producing a document ticket so as to register a method, which can be performed in the session started with the new document ticket, in the management table of the methods which can be performed with the document ticket.

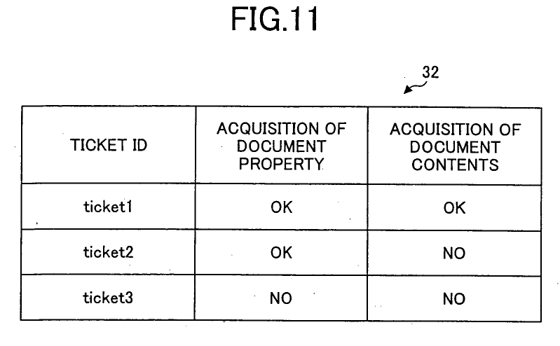

FIG. 11 is an illustration showing an example of methods which can be performed with a document ticket.

In a management table 32 of methods which can be performed with a document ticket illustrated in FIG. 11, an availability of each service is registered for each ticket ID. In the example of the management table 32, permission for acquisition of document property and contents of a document, permission for only document property, and prohibition of acquisition of document property and contents of a document are registered with respect to the ticket IDs of ticket1, ticket2 and ticket3, respectively. It should be noted that the management table of methods shown in FIG. 11 is managed, for example, by the ticket managing means 13. Moreover, although the description was given with reference to FIG. 11, in the case where the management table is used, permission or prohibition of each service may be included in the document ticket itself.

According to the present variation, services associated with various documents can be offered without need of a direct access right to the document management server 1, and, in addition, the access right to the document management server 1 can be controlled, and, therefore, a flexible access control can be performed.

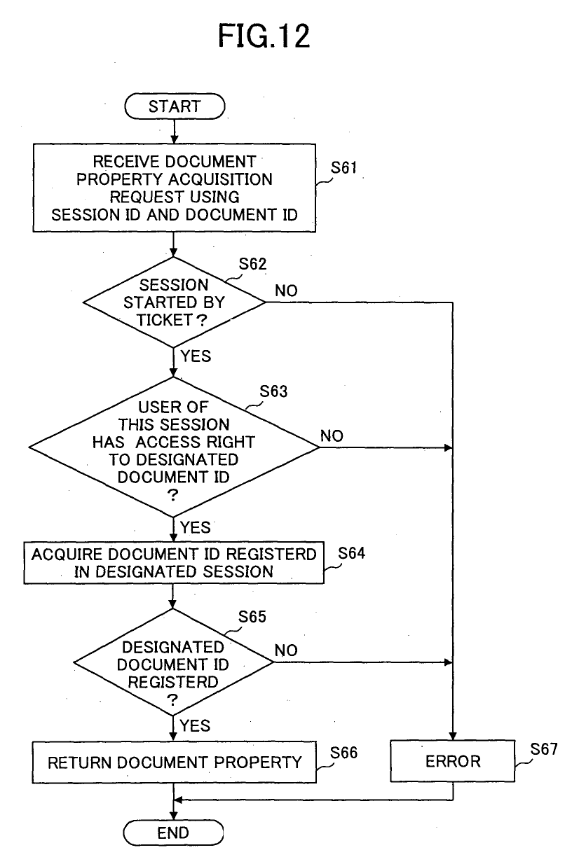

FIG. 12 is a flowchart for explaining a document property offering procedure according to a session started using a document ticket in a service offering method according to anther variation of the first embodiment of the present invention.

The service offering method according to another variation is set so that when the access right of documents is changed after acquiring a document ticket, the access right with respect to the session started with the document ticket is changed in the service offering method according to each of the above-mentioned embodiments.

In the process of acquiring document property in the session started with a document ticket in the document management server 1, a document property acquisition request is first received by setting as arguments the session ID of the session started with the document ticket and the document ID of he document of which property has been acquired (step S61). Next, it is determined (step S62) whether or not the session has been started using the document ticket b. If it is not the session which has been started with the document ticket b, error information is output (step S67). If it is the session which was started with the document ticket b, it is determined (step S63) whether or not the user of the session has an access right to the designated document ID. If there is no access right in step S63, the routine proceeds to step S67. If the user has the access right, the document ID registered in the designated session is acquired (step S64). Next, it is determined (step S65) whether or not the designated document ID is registered for the session. If not registered, the routine proceeds to step S67. If registered, the document property is returned to the client B (3) (step S66). Thus, in the document management server 1, it is checked before performing the acquisition of property whether the user (user who acquired the document ticket) of the session has an access right to the document corresponding to the designated document ID. According to the present embodiment, services associated with various documents can be offered without need of a direct access right to the document management server 1. In addition, when the account information leaks to a third party, the document ticket and the session started by the document ticket can be invalidated by merely invalidating the account.

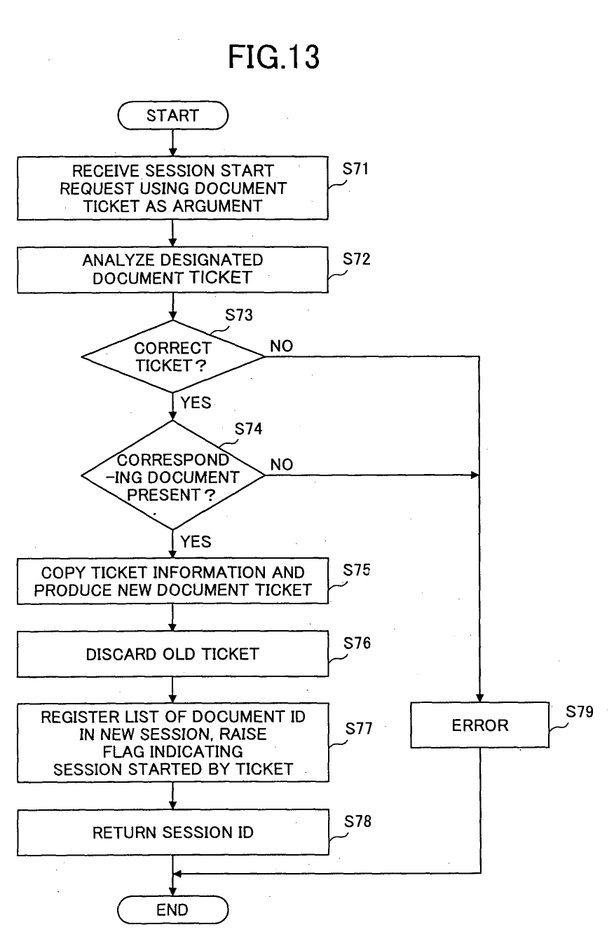

FIG. 13 is a flowchart for explaining a process procedure for discarding an old ticket when starting a session according to a document ticket in a service offering method according a variation of the first embodiment of the present invention.

In the variation of the service offering method according to the first embodiment of the present invention, an original document ticket may be updated when a session is newly started with a document ticket in the service offering methods according the first embodiment and variations thereof.

In the process of discarding an old ticket when starting a session according to a document ticket in the document management server, a session start request is first received by setting the document ticket as an argument (step S71), and the designated document ticket is analyzed (step S72). Next, it is determined (step S73) whether the document ticket is a correct ticket. If it is not a correct ticket, error information is output (step S79). On the other hand, if it is a correct ticket, it is determined (step S74) whether or not the document ticket concerned is present. If it is not present, the routine proceeds to step S79. If it is present, the routine proceeds to step S75. In step S75, ticket information is copied so as to produce a new document ticket. Although the produced document ticket is a copy, it is different from the old document ticket in the random information or date information, for example. Next, in order to avoid reuse of the old document ticket, the old ticket is discarded (step S76). Additionally, a new session is produced from either the new or old document ticket, and a list of document IDs is registered in the session, and a flag indicating that the session has been started using the document ticket (step S77). It should be noted that the order of step S76 and step S77 can be reversed. Here, the flag, which is needed when starting a session with the ticket as an argument and indicates that the session has been started using the ticket, is raised. Finally, a session ID is returned to the client B (3) (step S78). The session ID may be random.

Thus, in the document management server 1, after confirming that the document ticket is a correct document ticket, the old document ticket is copied so as to produce a new document ticket. Then, the old document ticket is discarded. It should be noted that the new document ticket produced can be transferred from the client B (3) to another client C directly or through the client A (2), and used by the client C, or may be used when the client B (3) performs a plurality of methods for a plurality of times.

According to this variation of the first embodiment, services associated with various documents can be offered without need of a direct access right to the document management server 1. Additionally, since tow session cannot be started with the same document ticket, the document ticket can be prevented from being misappropriated.

It should be noted that a flag indicating prohibition of use may be raised for an old flag without discarding the old flag.

In the above, although the service offering methods and apparatuses according to the first embodiment and variations thereof were explained, the document management server 1 in the first embodiment and its variations may be applied to a CS system comprising a server and clients.

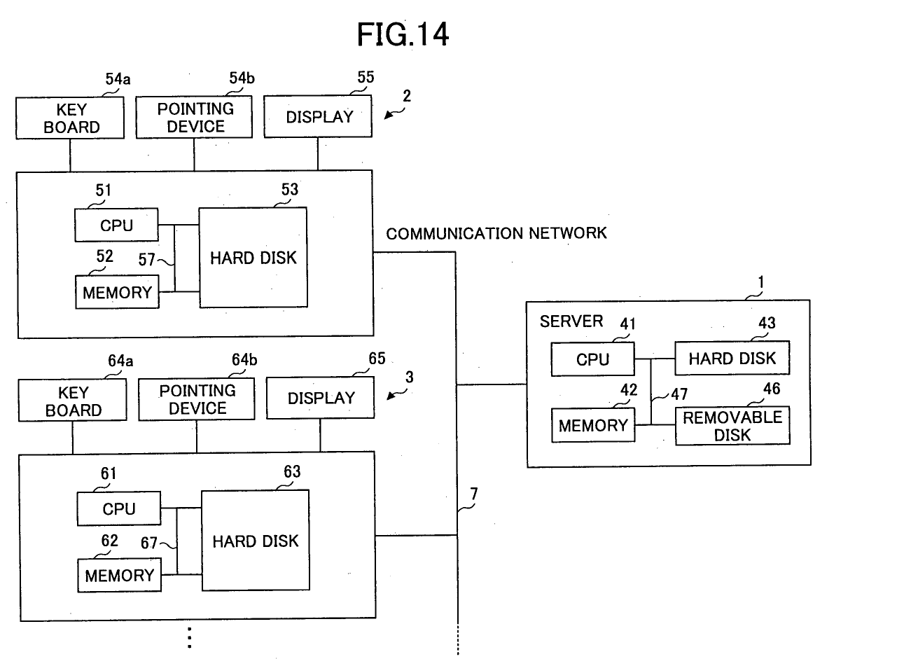

A description will now be given, with reference to FIG. 14, of a general CS system to which the present invention is applied. FIG. 14 is a block diagram of a hardware structure of A general CS system. The CS system shown in FIG. 14 is constituted by the document management server 1 as a data management system and clients 2, 3, . . . connected to the document management server 1 through a network 7. The document management server 1 according to the present invention can also be constituted by forming a part of the means shown in FIG. 3 as a hard module.

Data handled by the document management server 1 according to the present invention is temporarily stored in a memory 42 such as a random access memory (RAM) at the time of processing. A service offering program and necessary data are stored in a memory part such as a read only memory (ROM) including a hard disk 43. The service offering program describes a process performed by a central processing unit (CPU) 41 which causes a computer to function as a system such as, for example, each means shown in FIG. 3. The CPU 41 performs the service offering method according to the present invention by reading the service offering program (control program), and stores the management table and produced document ticket in the hard disk 43 or a removable disk 46 such as a CD-ROM. It should be noted that the CPU 41, the memory part including the memory 42 and the hard disk 43 and the removable disk 46 may be connected to each other by a bus (internal bus) 47, or a part of each element may be connected through a network such as a LAN. The service offering program may be stored in the removable disk 46, which may be a processor readable recording medium such as a CD-ROM, and is read by the CPU 41 and stored in the memory 42. Additionally, the document management server 1 may adopts a form having a hierarchical structure. It should be noted that communication through the network 7 is also be controlled according to instructions by the CPU 41 (and CPUs 51 and 61).

On the side of the clients 2 and 3, the document ticket, data property, contents of data, etc. that are received through the network 7 according to the control program are output to an output unit such as a display 55 including a CRT, an LCD or a PDP, a connected printer or a communication port. Moreover, the clients 2, 3 are provided with a graphical user interface (GUI) for the display 55 which facilitates operations by a user so that various kinds of data are presented to the user through the GUI. When it is necessary, the user may input parameters (user information (user account information) needed at the time of acquiring the document ticket) necessary for processing through keyboards 54a and 64a or mouse devices (pointing devices) 54b and 64b. Moreover, the intermediate data produced during execution of other processes are also stored in the memory 52 and 62 such as RAMs, and read or write of the intermediated data is performed by the CPUs 51 and 61, if needed. It should be noted that the CPU 51 (61), the memory part including the memory 52 (62) and the hard disk 53 (63), the input units 54a and 54b (64a and 64b), the display 55 (65) and the output unit on the side of the client 2 (3) may be connected through a bus (internal bus) 57 (67), or parts of the elements may be connected to each other through a network such as a LAN.

(Second Embodiment)

A description will now be given of a second embodiment of the present invention.

Although a description was omitted in the above-mentioned first embodiment, when the client A (2) transmits an acquisition request for a document ticket to the document management server 1, for example, in FIG. 2, the acquisition request for the document ticket is transmitted to the document management server 1 by including a session ID in the acquisition request for the document ticket. The document management server 1 determines whether or not the session is an effective session with reference to the session ID contained in the request. If it is determined that the session is effective, the document management server 1 performs a process responsive to the request. That is, the client A (2) and the document management server 1 establishes a session first.

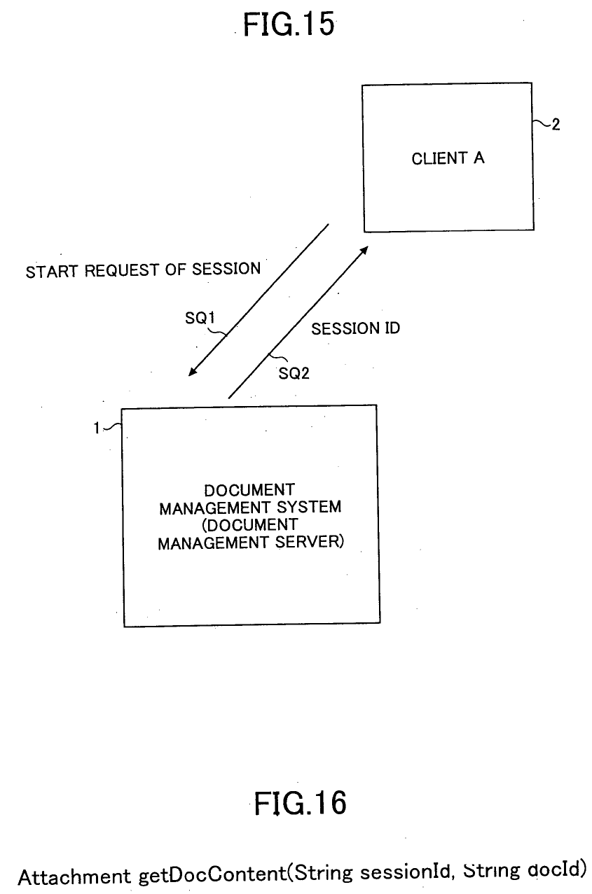

A description will now be given below, with reference to FIG. 15, of a process of starting a session between the document management server 1 and the client A (2). FIG. 15 is an illustration for explaining a process for starting a session between the document management server 1 and the client A.

The client A (2) transmits a start request of the session containing, for example, a user name and a password to the document management server 1 (sequence SQ1).

The document management server 1 performs authentication based on, for example, the user name and the password contained in the start request of the session. If it is a correct combination, the document management server 1 produces the session, and transmits a session ID which identifies the session to the client A (2) (sequence SQ2).

The client A (2) requests to the document management server 1 an acquisition of the contents (attachment) of the document which is managed by the document management server 1 by using the acquired session ID.

A description will be given below, with reference to FIG. 16, of a method of acquiring contents of a document provided by the document management server 1. FIG. 16 is an illustration for explaining an example of the method of acquiring contents of a document. The method of document contents acquisition acquires a session ID (sessionid) and a document ID (docId) as arguments, and returns the contents of the document as a return value. The client A (2) calls a document contents acquisition method provided by the document management server 1 as shown in FIG. 15 by passing the session ID and the document ID so as to acquire the contents of the document.

Here, in the first embodiment, the client A (2) acquires a document ticket from the document management server 1 and passes the document ticket to the client B (3) so that the client B (3) establishes a session having a limited right with the document management server 1 so as to use services associated with documents offered by the document management server 1.

However, services associated with the documents may be used by the client B (3) within a limited right, as mentioned in the first embodiment, without using a document ticket by processing a session ID, which identifies the session between the document management server 1 and the client A (2), by the client A (2) or the 9 processes the session ID which discriminates document management server 1 and passing the processed session ID to the client B (3).

A description will be given below of a service offering method or a service offering apparatus (the document management apparatus 1 in the present embodiment) using the session ID which identifies a session between the client A (2) and the document management server 1. It should be noted that the hardware structures of the document management server 1, the client A (2) and the client B (3) are the same as that explained in the above-mentioned first embodiment. However, programs which perform operations as mentioned below are stored in the document management server 1, the client A (2) and the client B (3) so that the document management server 1, the client A (2) and the client B (3) perform processes in accordance with the program stored therein.

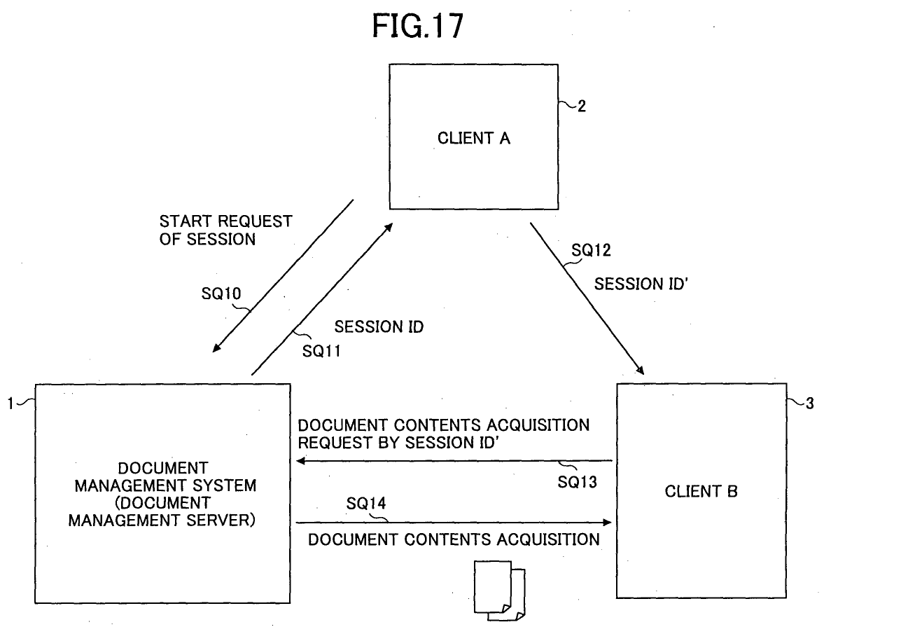

A description will be given below, with reference to FIG. 17, of an acquisition process of contents of a document using a processed session ID. FIG. 17 is an illustration (part 1) for explaining a process associated with an acquisition of contents of a document using a processed session ID.

The client A (2) transmits a start request of a session containing a user name and a password to the document management server 1 (sequence SQ10).

The document management server 1 performs authentication based on, for example, the user name and the password contained in the start request of the session. If it is a correct combination, the document management server 1 produces the session, and transmits a session ID which identifies the session to the client A (2) (sequence SQ11).

The client A (2) produces a session ID′ by adding a document ID, which is used as an object to be operated, to the acquired session ID.

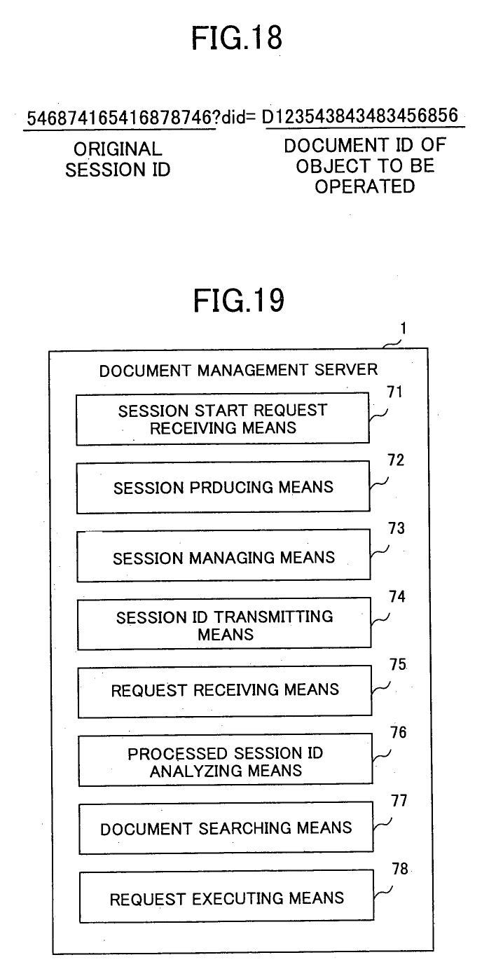

FIG. 18 is an illustration (part 1) for explaining the session ID′.

As shown in FIG. 18, if the session ID acquired from the document management server 1 in the sequence SQ11 is “5468746165416878746” and the document ID of the object to be operated is “5468746165416878746”, the client A (2) processes the original session ID so as to produce the session ID′ “5468746165416878746 ?did=D123543843483456856”. Here, “?” represents a separator. It should be noted that FIG. 18 shows an example in which a single document ID is added, this does not limit the present invention. A plurality of document IDs of objects to be operated may be added to the session ID to as to produce a new session ID′. It is the same in the description below.

In FIG. 17, the client A (2) transmits the produced session ID′ to the client B (3) (sequence SQ12). The client B (3) transmits an acquisition request of the contents of the document containing the session ID′ which is received from the client A (2) to the document management server 1 (sequence SQ13).

The document management server 1 determined the effectiveness of the session ID′. If it is an effective session ID′, the document management server 1 acquires the contents of the document corresponding to the document ID, and transmits the contents of the document to the client B (3) (sequence SQ14).

The client A (2) calls the contents acquisition method of documents which the document management server 1 offers in a form like getDocContent (“5468746165416878746?did=D1235438434834568 56”, “D123543843483456856”).

A description will be given below, with reference to FIG. 19, of a functional structure of the document management server 1 shown in FIG. 17. FIG. 19 is a functional block diagram of an example of the document management server shown in FIG. 17.

As shown in FIG. 19, the document management server 1 comprises a session start request receiving means 71, a session producing means 72, a session managing means 73, a session ID transmitting means 74, a request receiving means 75, a processed session ID analyzing means 76, a document searching means 77 and a request executing means 78.

The session start request receiving means 71 receives a start request of a session from the client A (2). The start request of a session contains a user name and a password. The session producing means 72 produces a session between the client A (2) and the document management server 1 concerned according to the start request of a session which the session start request receiving means 71 received. It should be noted that the session contains a session ID for identifying the session concerned and a term of validity of the session concerned.

The session managing means 73 manages the session produced by the session producing means 72. The session ID transmitting means 74 transmits the session ID which identifies the session produced by the session producing means 72 to the client A (2) which made the request. The request receiving means 75 receives a request for a process (or method) associated with a document containing the processed session ID (session ID′). The processed session ID analyzing means 76 analyzes the processed session ID (session ID′) which is contained in the request received by the request receiving means 75. The document searching means 77 searches for the document corresponding to the document ID contained in the request received by the request receiving means 75, and checks the presence of the document concerned. The request executing means 78 executes the request received by the request receiving means 75 (causes a corresponding means to perform a service offering process requested).

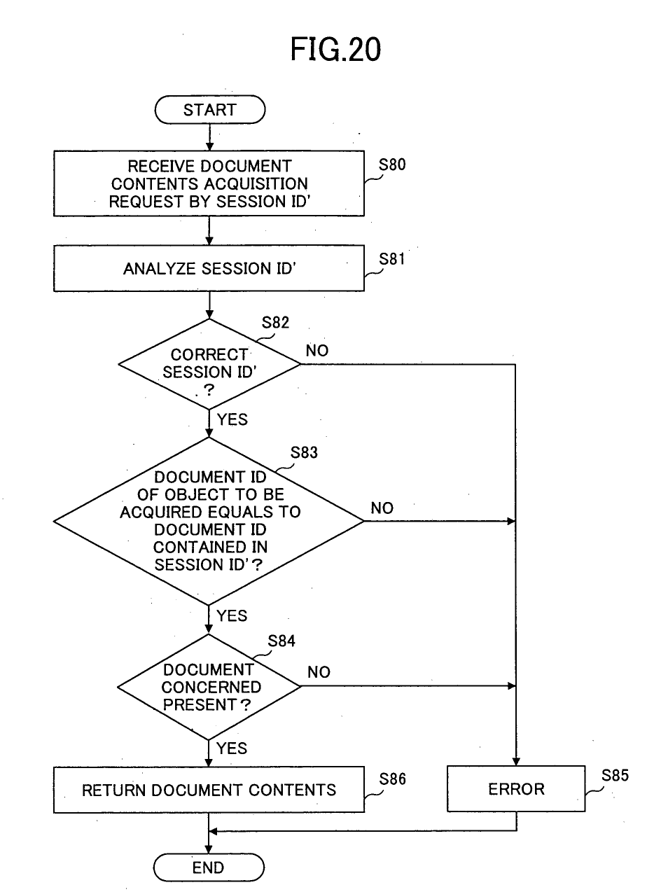

A description will now be given below, with reference to FIG. 20, of a process associated with a document contents acquisition using a session ID′. FIG. 20 is a flowchart (part 1) for explaining a process associated with a document contents acquisition using a session ID′ in the document management server.

In step S80, the document management server 1 receives from the client B (3) an acquisition request of the contents of a document which contains the session ID′ explained with reference to FIG. 18. Subsequent to step S80, the routine proceeds to step S81 where the document management server 1 analyzes the session ID′ contained in the acquisition request of the contents of a document which received in step S80, and retrieves an original session ID prior to be processed and a document ID contained in the session ID′. Subsequent to step S81, the routine proceeds to step S82 where the document management server 1 determines whether or not the session ID′ is a valid session ID′. If it determined that the session ID′ is valid, (YES in step S82), the routine proceeds to step S83. If it is determined that the session ID′ is not valid (NO in step S82), the routine proceeds to step S85. For example, the document management server 1 determines whether or not the session ID′ is valid by checking whether or not the session ID is valid based on the original session ID contained in the session ID′ by referring to the session managing means 73, etc.

In step S83, the document management server 1 determines whether or not the document ID contained in the session ID′ is equal to the document ID given as an object to acquire the contents of a document. If it is determined that they are the same document ID (YES in step S38), the routine proceeds to step S84. If it is determined that they are not the same document ID, the routine proceeds to step S85. For example, the document management server 1 determines whether or not the document ID contained in the session ID′ of a first argument of the method “getDocContent” is the same as the document ID of a second argument.

In step S84, the document management server determines whether or not there is a document corresponding to the document ID. If it determined that there is a document corresponding to the document ID (YES in step S84), the routine proceeds to step S86. If it determined that there is no document corresponding to the document ID (NO in step S84), the routine proceeds to step S85. In step S85, the document management server 1 performs an error process. For example, the document management server 1 produces an error message, and transmits the error massage to the client B (3). In step S86, the document management server 1 acquires the contents of the document corresponding to the document ID, and transmits the contents of the document to the client B (3).

As shown in FIGS. 17-20, the client B (3) can use services associated with the documents offered by the document management server 1 by using the session ID′ since the client A (2) processes the session ID and produces the session ID′ so as to pass the session ID′ to the client B (3).

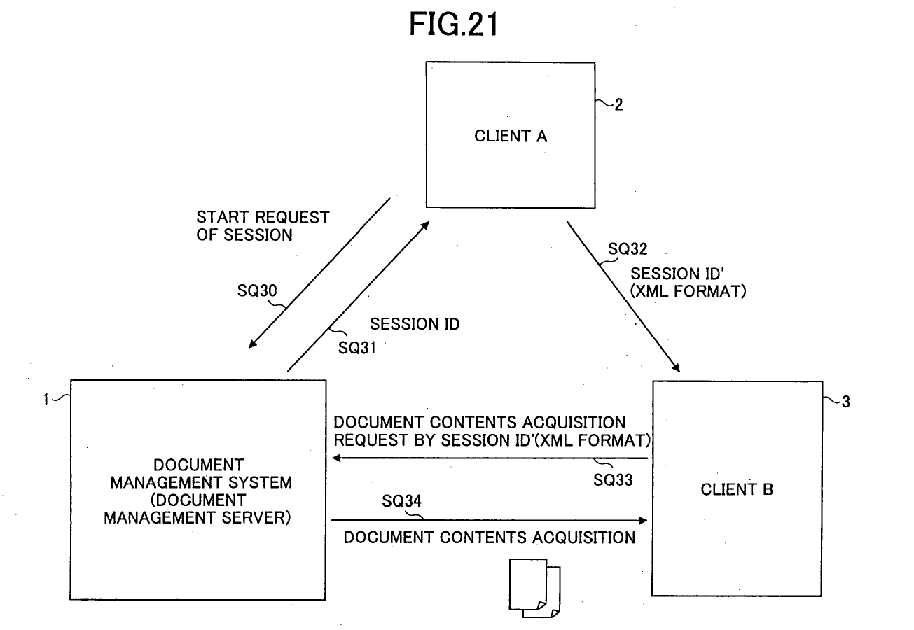

A description will be given below, with reference to FIG. 21, of another example of the process associated with acquisition of the contents of a document using a processed ID. FIG. 21 is an illustration (part 2) for explaining another example of the process associated with acquisition of the contents of a document using a processed session ID.

The client A (2) transmits to the document management server 1 a start request of a session containing, for example, a user name and a password (sequence SQ20). The document management server 1 performs an authentication based on, for example, the user name and the password contained in the start request of a session, and produces a session when they are a correct combination. Then, the document management server 1 transmits a session ID which identifies the session to the client A (2) (sequence SQ21). The client A (2) adds the document ID used as an object to be operated to the acquired session ID so as to produce the session ID′.

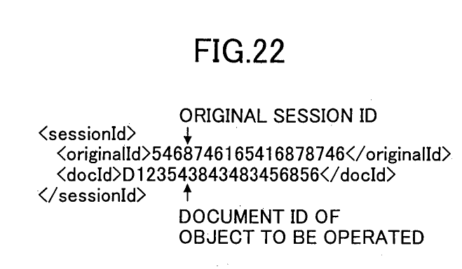

When the session ID acquired from the document management server 1 in the sequence SQ21 is “5468746165416878746” and the document ID of the object to be operated is “D123543843483456856” as shown in FIG. 22, the client A (2) processes the original session ID so as to produce a session ID′ of an the XML format. In FIG. 21, the client A (2) transmits the processed session ID′ of the XML format to the client B (3) (sequence SQ22). The client B (3) transmits to the document management server 1 an acquisition request of the contents of the document containing the session ID′ of the XML format which was received from the client A (2) (sequence SQ23).

The document management server 1 determines the validity of the session ID′. If it is a valid session ID′, the document management server 1 acquires the contents of the document corresponding to the document ID, and transmits the acquired contents of the document to the client B (3) (sequence SQ24). The functional structure of the document management server 1 of FIG. 21 is the same as the functional structure explained with reference to FIG. 19.

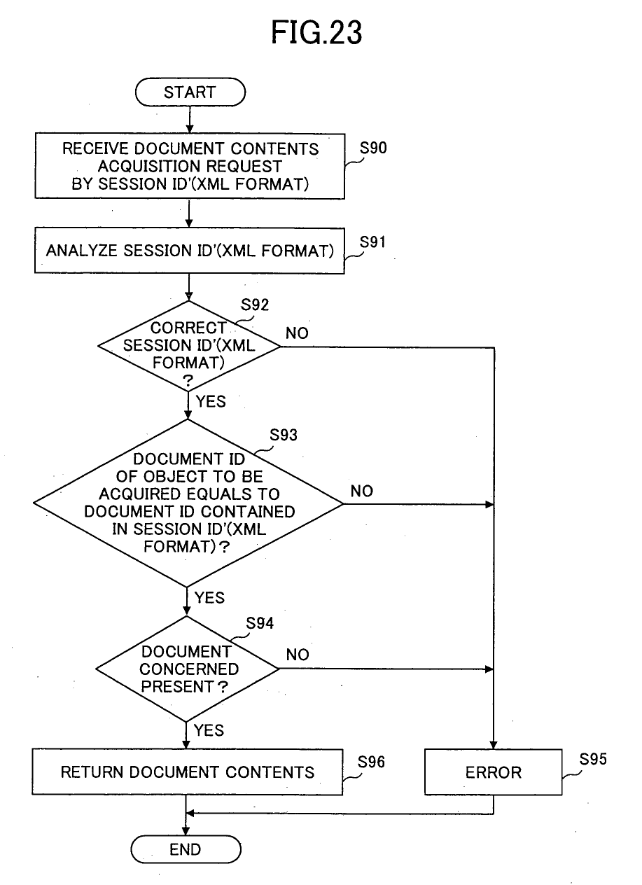

A description will be given below, with reference to FIG. 23, of another example of the process associated with acquisition of the contents of a document using the session ID′. FIG. 23 is a flowchart (part 2) for explaining a process associated with acquisition of the contents of a document using the session ID′ in the document management server.

In step S90, the document management server 1 receives from the client B (3) an acquisition request of the contents of a document which contains a session ID′ of the XML format explained with reference to in FIG. 22. Subsequent to step S90, the routine proceeds to step S91 where the document management server 1 analyzes the session ID′ of the XML format included in the acquisition request of the contents of a document which was received in step S90, and retrieves an original session ID prior to be processed and a document ID contained in the session ID′.

Subsequent to step S91, the routine proceeds to step S92 where the document management server 1 determines whether or not the session ID′ of the XML format is a valid session ID′. If it is determined that the session ID′ is valid (YES in step S92), the routine proceeds to step S93. If it is determined that the session ID′ is not valid (NO in step S92), the routine proceeds to step S95. For example, the document management server 1 determines whether or not the session ID′ is valid by checking whether the session ID7 is valid based on the original session ID contained in the session ID′ of the XML format by referring to the session managing means 73, etc.

In step S93, the document management server 1 determines whether or not the document ID contained in the session ID′ is equal to the document ID given as an object to acquire the contents of a document. If it is determined that they are the same document ID (YES in step S93), the routine proceeds to step S94. If it is determined that they are not the same document ID, the routine proceeds to step S95.

In step S94, the document management server determines whether or not there is a document corresponding to the document ID. If it determined that there is a document corresponding to the document ID (YES in step S94), the routine proceeds to step S96. If it determined that there is no document corresponding to the document ID (NO in step S94), the routine proceeds to step S95. In step S95, the document management server 1 performs an error process. For example, the document management server 1 produces an error message, and transmits the error massage to the client B (3). In step S96, the document management server 1 acquires the contents of the document corresponding to the document ID, and transmits the contents of the document to the client B (3).

As shown in FIGS. 21-23, the client B (3) can use services associated with the documents offered by the document management server 1 by using the session ID′ of the XML format since the client A (2) processes the session ID and produces the session ID′ of the XML format so as to pass the session ID′ of the XML format to the client B (3).

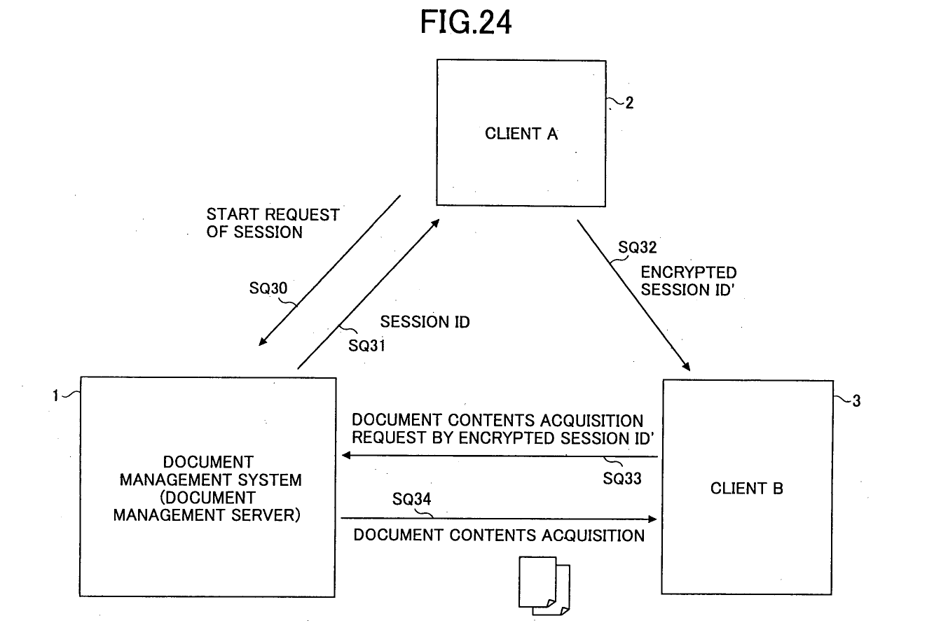

A description will be given below, with reference to FIG. 24, of another example of the process associated with acquisition of the contents of a document using a processed session ID. FIG. 24 is an illustration (part 3) for explaining another example of the process associated with acquisition of the contents of a document using a processed session ID.

The client A (2) transmits to the document management server 1 a start request of a session containing, for example, a user name and a password (sequence SQ30). The document management server 1 performs an authentication based on, for example, the user name and the password contained in the start request of a session, and produces a session when they are a correct combination. Then, the document management server 1 transmits a session ID which identifies the session to the client A (2) (sequence SQ31). The client A (2) adds the document ID used as an object to be operated to the acquired session ID so as to produce the session ID′. Additionally, the client A (2) encrypts the produced session ID′ using a public key common to the document management server 1. Then, the client A (2) transmits the encrypted session ID′ to the client B (3) (sequence SQ32).

The client B (3) transmits to the document management server 1 an acquisition request of the contents of the document containing the encrypted session ID′ which was received from the client A (2) (sequence SQ33). Then, the document management server 1 decrypts the encrypted session ID′ by the public key common to the client A (2), and determines the validity of the decrypted session ID′. If the decrypted session ID′ is valid, the document management server 1 acquires the contents of the document corresponding to the document ID, and transmits the contents of the document to the client B (3) (sequence SQ34).

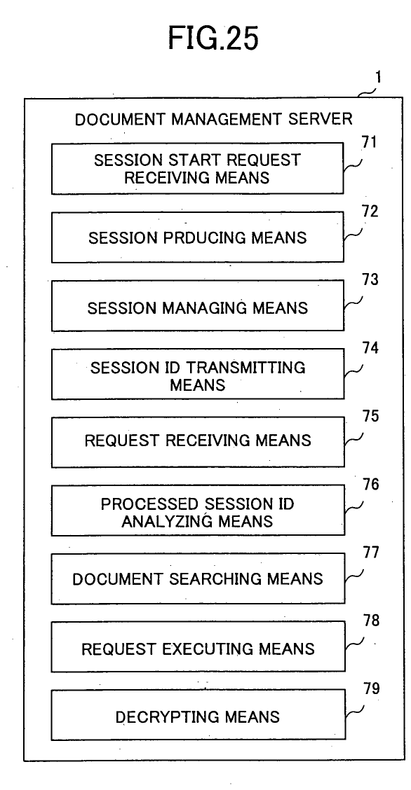

A description will be given below, with reference to FIG. 25, of a functional structure of the document management server 1 shown in FIG. 24. FIG. 25 is a functional block diagram of an example of the document management server shown in FIG. 24. In FIG. 25, parts that are the same as the parts shown in FIG. 19 are given the same reference numerals, and descriptions thereof will be omitted.

As shown in FIG. 25, the document management server 1 comprises a session start request receiving means 71, a session producing means 72, a session managing means 73, a session ID transmitting means 74, a request receiving means 75, a processed session ID analyzing means 76, a document searching means 77, a request executing means 78 and a decrypting means 79.

The decrypting means 79 decrypts the encrypted session ID′ contained in the request of the process (method) associated with the document from the client B (3) by using a common key common to the client A (2). It should be noted that the means other than the decrypting means are the same as the means explained with reference to FIG. 19.

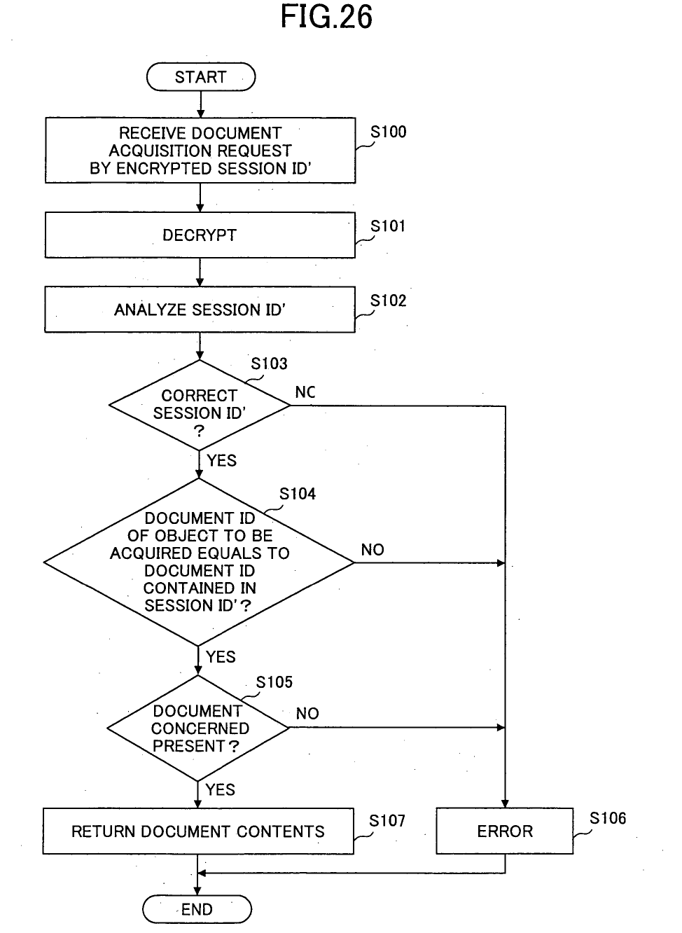

A description will now be given below, with reference to FIG. 26, of a process associated with a document contents acquisition using a session ID′. FIG. 26 is a flowchart (part 3) for explaining another example of the process associated with a document contents acquisition using a session ID′ in the document management server.

In step S100, the document management server 1 receives from the client B (3) an acquisition request of the contents of a document which contains the session ID′. Subsequent of step S100, the routine proceeds to step S101 where the document management server 1 decrypts the session ID′ contained in the acquisition request of the contents of the document which was received in step S100 by using the common key common to the client A (2).

Subsequent to step S101, the routine proceeds to step S102 where the document management server 1 analyzes the session ID′ decrypted in step S101, and retrieves an original session ID prior to be processed and a document ID contained in the session ID′. Subsequent to step S102, the routine proceeds to step S103 where the document management server 1 determined whether or not the session ID′ is a valid session ID′. If it determined that the session ID′ is valid, (YES in step S103), the routine proceeds to step S104. If it is determined that the session ID′ is not valid (NO in step S103), the routine proceeds to step S106. For example, the document management server 1 determines whether or not the session ID′ is valid by checking whether or not the session ID is valid based on the original session ID contained in the session ID′ by referring to the session managing means 73, etc.

In step S104, the document management server 1 determines whether or not the document ID contained in the session ID′ is equal to the document ID given as an object to acquire the contents of a document. If it is determined that they are the same document ID (YES in step S104), the routine proceeds to step S105. If it is determined that they are not the same document ID (NO in step S104), the routine proceeds to step S106.

In step S105, the document management server determines whether or not there is a document corresponding to the document ID. If it determined that there is a document corresponding to the document ID (YES in step S105), the routine proceeds to step S107. If it determined that there is no document corresponding to the document ID (NO in step S105), the routine proceeds to step S106. In step S106, the document management server 1 performs an error process. For example, the document management server 1 produces an error message, and transmits the error massage to the client B (3). In step S107, the document management server 1 acquires the contents of the document corresponding to the document ID, and transmits the contents of the document to the client B (3).

The client B (3) calls the document contents acquisition methods offered by the document management server 1 by setting the session ID′ encrypted by the public key as a first argument and the document ID as a second argument.

As shown in FIGS. 24-26, the client B (3) can use, within a limited right, services associated with the documents offered by the document management server 1 by using the encrypted session ID′ while maintaining a security since the client A (2) processes the session ID and produces the session ID′ and encrypts the session ID′ by using the common key common to the document management server 1 so as to pass the encrypted session ID′ to the client B (3).

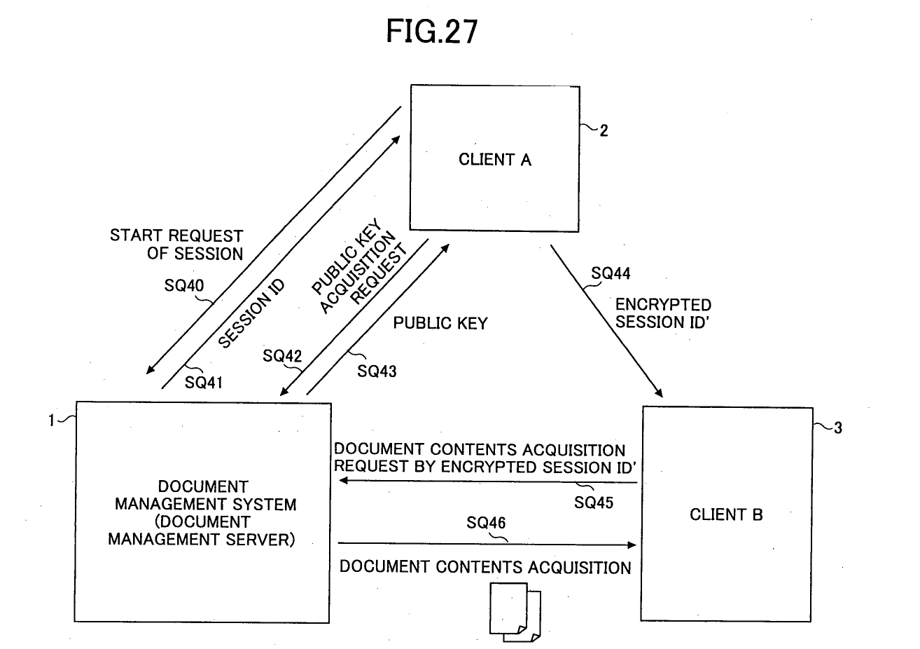

A description will be given below, with reference to FIG. 27, of another example of the process associated with acquisition of the contents of a document using a processed session ID. FIG. 27 is an illustration (part 4) for explaining another example of the process associated with acquisition of the contents of a document using a processed session ID.

The client A (2) transmits to the document management server 1 a start request of a session containing, for example, a user name and a password (sequence SQ40). The document management server 1 performs an authentication based on, for example, the user name and the password contained in the start request of a session, and produces a session when they are a correct combination. Then, the document management server 1 transmits a session ID which identifies the session to the client A (2) (sequence SQ41).

The client A (2) transmits an acquisition request of the public key of the document management server 1 to the document management server 1 (sequence SQ42). Then, the document management server 1 determines validity of the session ID contained in the acquisition request of the public key. If it is determined that the session ID is valid, the document management server transmits the public key to the client A (2) (sequence SQ43).

The client A (2) processes the session ID acquired in the sequence SQ 41 as shown in FIG. 18 or FIG. 22 so as to produce a session ID′. Then, the client A (2) encrypts the session ID′ by using the public key of the document management server 1 acquired from the document management server 1. The client A (2) transmits the encrypted session ID′ to the client B (3) (sequence SQ44).

The client B (3) transmits to the document management server 1 an acquisition request of the contents of the document containing the encrypted session ID′ received from the client A (2) (sequence SQ46).

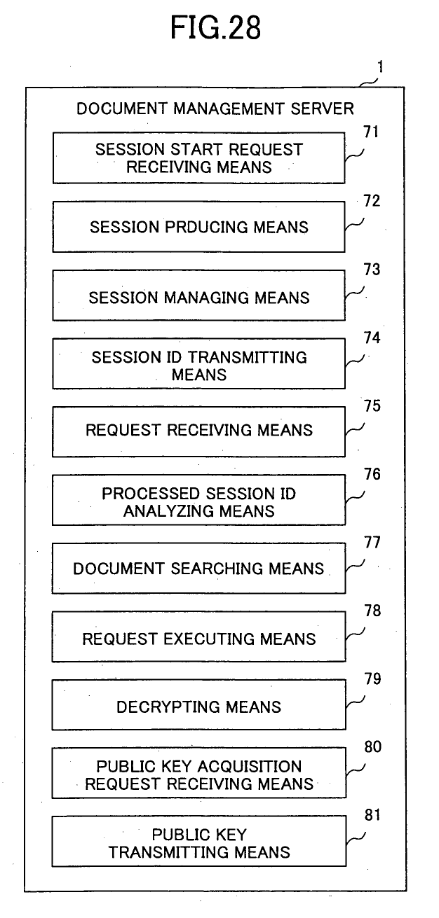

A description will be given below, with reference to FIG. 28, of a functional structure of the document management server 1 shown in FIG. 27. FIG. 28 is a functional block diagram of an example of the document management server shown in FIG. 27. In FIG. 28, parts that are the same as the parts shown in FIG. 19 and FIG. 25 are given the same reference numerals, and descriptions thereof will be omitted.

As shown in FIG. 28, the document management server 1 comprises a session start request receiving means 71, a session producing means 72, a session managing means 73, a session ID transmitting means 74, a request receiving means 75, a processed session ID analyzing means 76, a document searching means 77, a request executing means 78, a decrypting means 79, a public key acquisition request receiving means 80 and a public key transmitting means 81.

The decrypting means 79 shown in FIG. 28 decrypts the encrypted session ID′ contained in the request of the process (method) associated with the document from the client B (3) by using a secret key.

The public key acquisition request receiving means 80 receives an acquisition request of the public key from the client A (2). It should be noted that the session ID is contained in the acquisition request of the public key. The public key transmitting means 81 transmits the public key to the client A (2) in response to the acquisition request of the public key from the client A (2).

It should be noted that means other than the decrypting means 79, the public key acquisition request receiving means 80 and the public key transmitting means 81 are the same as the means explained with reference to FIG. 19. Moreover, a flowchart of the acquisition of the contents of the document using the encrypted session ID′ in the document management server 1 of FIG. 27 is the same as that shown in FIG. 26. However, in the document management server 1 of FIG. 27, the encrypted session ID′ is decrypted using a secret key in a process corresponding to the process of step S101 of FIG. 26 since the session ID′ is encrypted by the public key of the document management server 1.

In the case of FIG. 27, the client B (3) calls the document contents acquisition methods offered by the document management server 1 by setting the session ID′ encrypted by the public key as a first argument and the document ID as a second argument.

As shown in FIGS. 27 and 28, the client B (3) can use, within a limited right, services associated with the documents offered by the document management server 1 by using the encrypted session ID′ while maintaining a security since the client A (2) processes the session ID and produces the session ID′ and encrypts the session ID′ by using the public key acquired from the document management server 1 so as to pass the encrypted session ID′ to the client B (3).

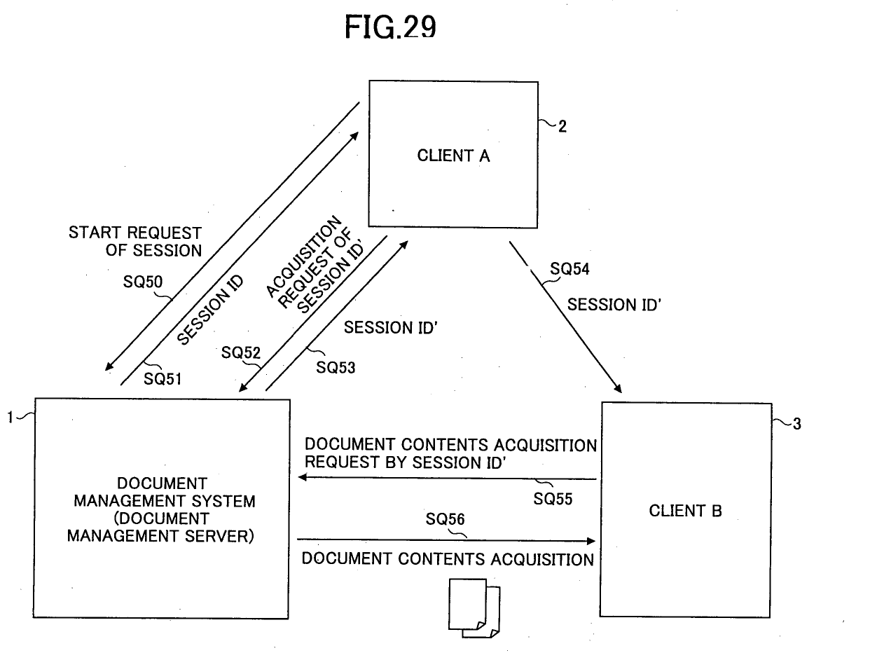

A description will be given below, with reference to FIG. 29, of another example of the process associated with acquisition of the contents of a document using a processed session ID. FIG. 29 is an illustration (part 5) for explaining another example of the process associated with acquisition of the contents of a document using a processed session ID.

The client A (2) transmits to the document management server 1 a start request of a session containing, for example, a user name and a password (sequence SQ50). The document management server 1 performs an authentication based on, for example, the user name and the password contained in the start request of a session, and produces a session when they are a correct combination. Then, the document management server 1 transmits a session ID which identifies the session to the client A (2) (sequence SQ51).

The client A (2) transmits to the document management server 1 an acquisition request of the session ID′ containing the acquired session ID and the document ID of an object to be operated (sequence SQ52). Then, the document management server 1 determines validity of the session ID contained in the acquisition request of the session ID′. If it is determined that the session ID is valid, the document management server 1 processes the session ID to produce the session ID′ as shown in FIG. 18 or FIG. 22, and transmits the session ID′ to the client A (2) (sequence SQ53).

The client A (2) transmits the acquired session ID to the client B (3) (sequence SQ54). The client B (3) transmits to the document management server 1 an acquisition request of the contents of the document containing the session ID′ received from the client A (2) (sequence SQ55).

The document management server 1 determines validity of the session ID′ contained in the acquisition request of the contents of the document of the session ID′ received from the client B (3). If the session ID′ is valid, the document management server 1 acquires the contents of the document corresponding to the document ID, and transmits the contents of the document to the client B (3) (sequence SQ56).

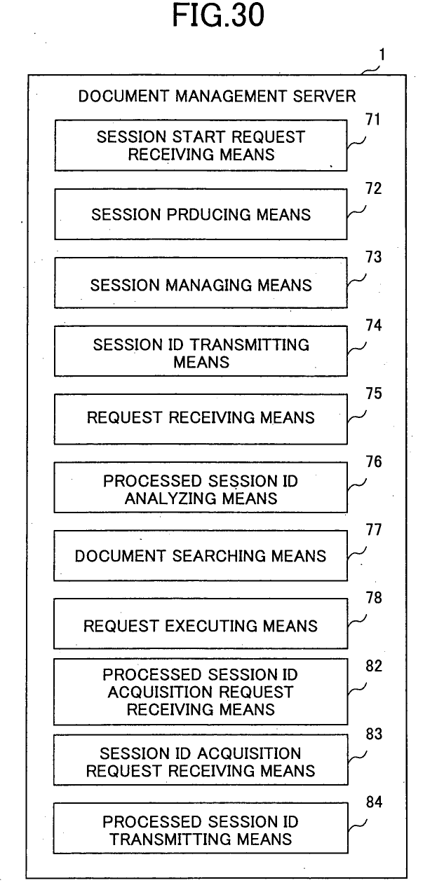

A description will be given below, with reference to FIG. 30, of a functional structure of the document management server 1 shown in FIG. 29. FIG. 30 is a functional block diagram of an example of the document management server shown in FIG. 29. In FIG. 30, parts that are the same as the parts shown in FIG. 19 are given the same reference numerals, and descriptions thereof will be omitted.

As shown in FIG. 30, the document management server 1 comprises a session start request receiving means 71, a session producing means 72, a session managing means 73, a session ID transmitting means 74, a request receiving means 75, a processed session ID analyzing means 76, a document searching means 77, a request executing means 78, a-decrypting means 79, a processed session ID transmitting means 82, a session ID processing means 83 and a processed session ID transmitting means 84.

The processed session ID acquisition request receiving means 82 receives an acquisition request of the session ID′ from the client A (2). The acquisition request of the session ID′ contains the session ID and the document ID of an object to be operated. The session ID processing means 83 process the session ID contained in this acquisition request, as shown in FIG. 18 or 22, in response to the acquisition request of the session ID′ which the processed session ID acquisition request receiving means 82 received, so as to produce the session ID′. The processed session ID transmitting means 84 transmits to the client A (2), which made the request, the session ID′ produced by processing the session ID in the session ID processing means 83.

It should be noted that means other than the processed session ID acquisition request receiving means 82, the session ID processing means 83 and the processed session ID transmitting means 84 are the same as the means explained with reference to FIG. 19.

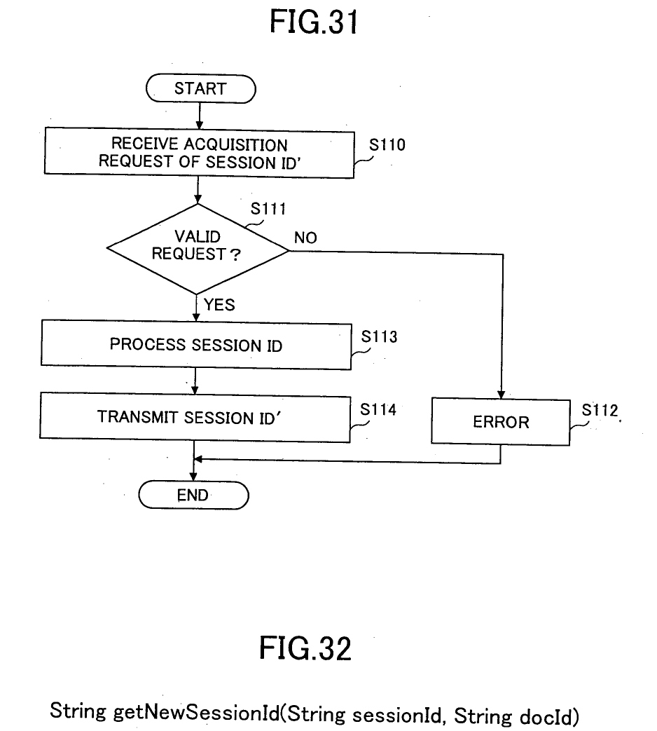

A description will be given below, with reference to FIG. 31, of an example of a process associated with processing of the session ID in the document management server 1 shown in FIG. 29. FIG. 31 is a flowchart for explaining a process associated with processing of the session ID in the document management server shown in FIG. 29.

In step S110, the document management server 1 receives an acquisition request of the session ID′ from the client A (2). Subsequent to step S110, the routine proceeds to step 111 where the document management server 1 determines whether or not the request received in step S110 is a valid request. If it is determined that the request is valid (YES in step 111), the routine proceeds to step S113. If it is determined that the request is not valid (NO in step 111), the routine proceeds to step S112.

The document management server 1 acquires the session ID contained in the acquisition request of the session ID′ which was received in step S110, and determined whether or not the session ID is valid by referring to the session managing means 73, etc. If it is determined that the session ID is valid, a determination is made that the request is a valid request. In step S112, the document management server 1 performs an error process. For example, the document management server 1 produces an error message, and transmits the error message to the client A (2).

In step S113, the document management server 1 processes the session ID, as shown in FIG. 18 or FIG. 22, so as to produce the session ID′. Subsequent to step 113, the routine proceeds to step 114 where the document management server 1 transmits to the client A (2), which made the request, the session ID′ which was processed and produced in step 113.

Here, an example of the method of acquiring the processed session ID (session ID′), which the document management server 1 offers and the client A (2) calls, is shown in FIG. 32. FIG. 32 is an illustration for explaining an example of the method of acquiring the processed session ID.

In the method of acquiring the processed session ID shown in FIG. 32, the session ID (sessionid) and the document ID (docId) are acquired as arguments, and the processed session ID (session ID′) is returned as a return value. The client A (2) passes the session ID and the document ID to the document management server 1 so as to call the method of acquiring the processed session ID which the document management server 1 offers as shown in FIG. 32, and acquires the processed session ID (session ID′). It should be noted that the process associated with the acquisition of the contents of the document in FIG. 29 is the same as that explained with reference to FIG. 20.

As shown in FIGS. 29-32, the document management server 1 may processes the session ID based on the request from the client A (2) so as to produce the session ID′. The client B (3) which received the session ID′ from the client A (2) can use services associated with the documents, which the document management server 1 offers, by using the session ID′ within a limited right.

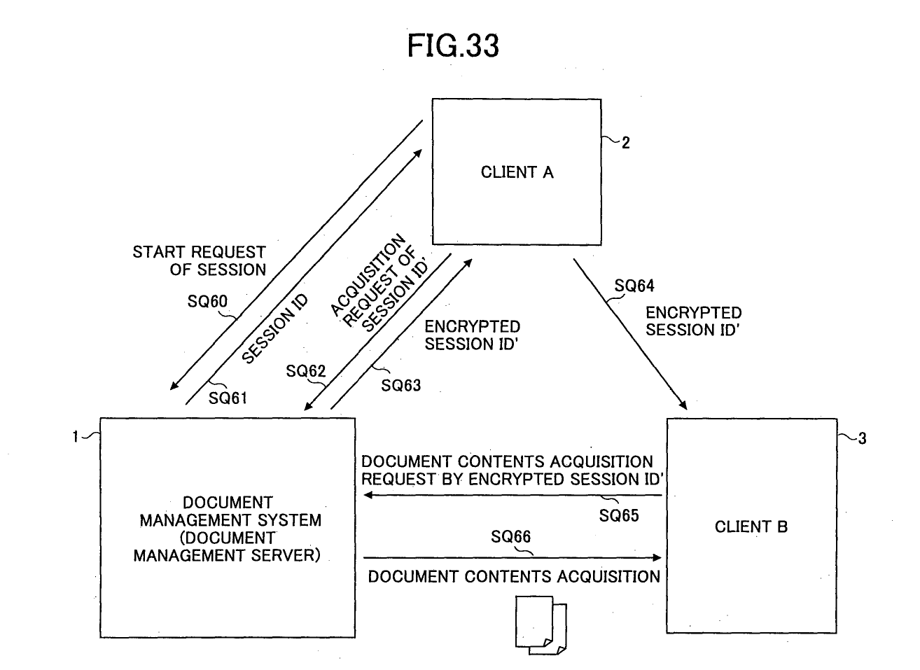

A description will be given below, with reference to FIG. 33, of another example of the process associated with acquisition of the contents of a document using a processed session ID. FIG. 33 is an illustration (part 6) for explaining another example of the process associated with acquisition of the contents of a document using a processed session ID.

The client A (2) transmits to the document management server 1 a start request of a session containing, for example, a user name and a password (sequence SQ60). The document management server 1 performs an authentication based on, for example, the user name and the password contained in the start request of a session, and produces a session when they are a correct combination. Then, the document management server 1 transmits a session ID which identifies the session to the client A (2) (sequence SQ61)

The client A (2) transmits to the document management server 1 an acquisition request of the session ID′ containing the acquired session ID and the document ID of an object to be operated (sequence SQ62). Then, the document management server 1 determines validity of the session ID contained in the acquisition request of the session ID′. If it is determined that the session ID is valid, the document management server 1 processes the session ID to produce the session ID′ as shown in FIG. 18 or FIG. 22. Then the document management server 1 encrypts the produced session ID′, and transmits the encrypted session ID′ to the client A (2) (sequence SQ63).

The client A (2) transmits the acquired, encrypted session ID to the client B (3) (sequence SQ64). The client B (3) transmits to the document management server 1 an acquisition request of the contents of the document containing the encrypted session ID′ received from the client A (2) (sequence SQ65).

The document management server 1 decrypts the encrypted session ID′ contained in the acquisition request transmitted by the client B (3), and determines validity of the decrypted session ID′. If the decrypted session ID′ is valid, the document management server 1 acquires the contents of the document corresponding to the document ID, and transmits the contents of the document to the client B (3) (sequence SQ66).

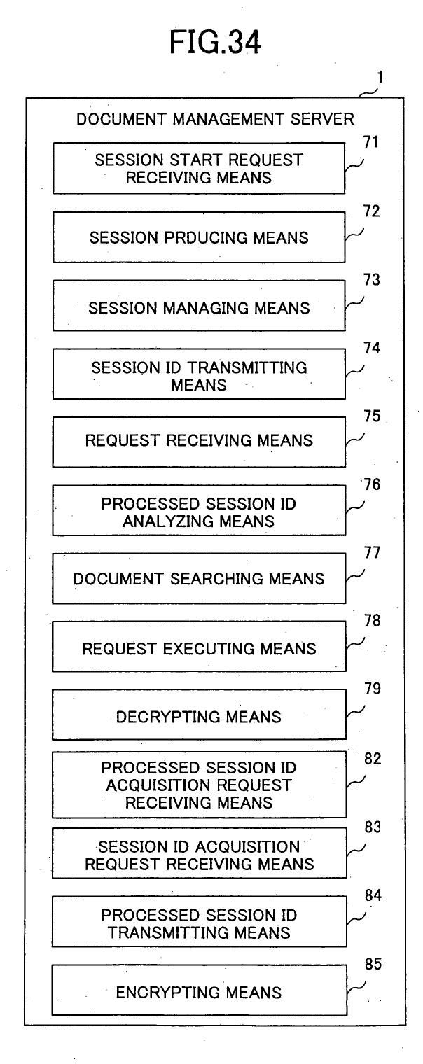

A description will be given below, with reference to FIG. 34, of a functional structure of the document management server 1 shown in FIG. 33. FIG. 34 is a functional block diagram of an example of the document management server shown in FIG. 33. In FIG. 33, parts that are the same as the parts shown in FIG. 30 are given the same reference numerals, and descriptions thereof will be omitted.

As shown in FIG. 34, the document management server 1 comprises a session start request receiving means 71, a session producing means 72, a session managing means 73, a session ID transmitting means 74, a request receiving means 75, a processed session ID analyzing means 76, a document searching means 77, a request executing means 78, a decrypting means 79, a processed session ID transmitting means 82, a session ID processing means 83, a processed session ID transmitting means 84 and a decrypting means 85.

The processed session ID acquisition request receiving means 82 receives an acquisition request of the session ID′ from the client A (2). The acquisition request of the session ID′ contains the session ID and the document ID of an object to be operated. The session ID processing means 83 process the session ID contained in this acquisition request, as shown in FIG. 18 or 22, in response to the acquisition request of the session ID′ which the processed session ID acquisition request receiving means 82 received, so as to produce the session ID′. The encrypting means 85 encrypts the session ID′ which was produced by processing the session ID in the session ID processing means 83. The processed session ID transmitting means 84 transmits to the client A (2), which made the request, the session ID′ encrypted by the encrypting means 85. The decrypting means 79 decrypts the session ID′ which was encrypted by the encrypting means 85.

It should be noted that means other than the decrypting means 79, the processed session ID acquisition request receiving means 82, the session ID processing means 83, the processed session ID transmitting means 84 and the encrypting means 85 are the same as the means explained with reference to FIG. 19.

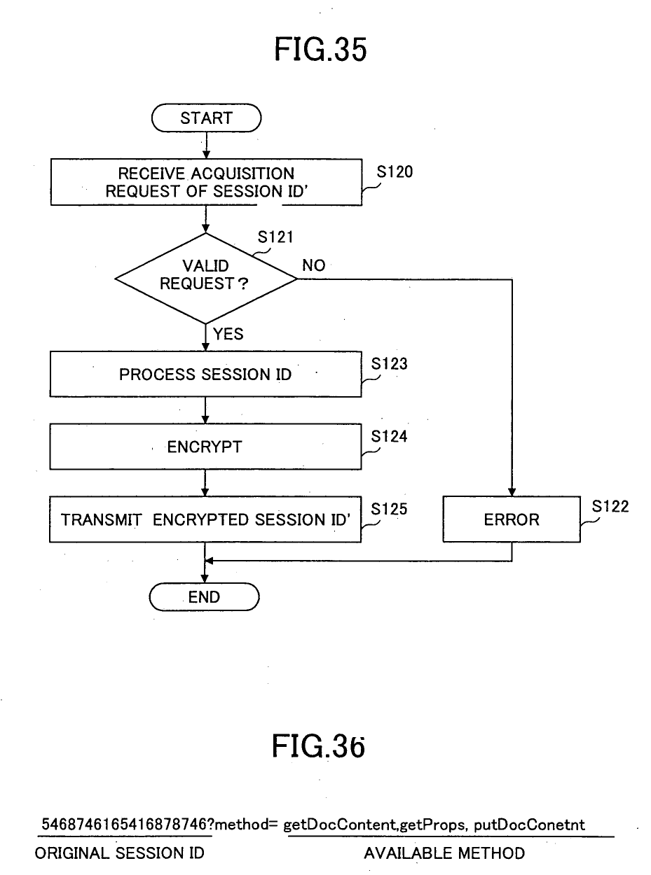

A description will be given below, with reference to FIG. 35, of an example of a process associated with processing of the session ID in the document management server 1 shown in FIG. 33. FIG. 35 is a flowchart for explaining a process associated with processing of the session ID in the document management server shown in FIG. 33.

In step S120, the document management server 1 receives an acquisition request of the session ID′ from the client A (2). Subsequent to step S120, the routine proceeds to step 121 where the document management server 1 determines whether or not the request received in step S110 is a valid request. If it is determined that the request is valid (YES in step 121), the routine proceeds to step S123. If it is determined that the request is not valid (NO in step 121), the routine proceeds to step S122.

The document management server 1 acquires the session ID contained in the acquisition request of the session ID′ which was received in step S120, and determines whether or not the session ID is valid by referring to the session managing means 73, etc. If it is determined that the session ID is valid, a determination is made that the request is a valid request. In step S122, the document management server 1 performs an error process. For example, the document management server 1 produces an error message, and transmits the error message to the client A (2).

In step S123, the document management server 1 processes the session ID, as shown in FIG. 18 or FIG. 22, so as to produce the session ID′. Subsequent to step S123, the routine proceeds to step S123 where the document management server 1 encrypts the session ID′ processed in step 123. Subsequent to step 124, the routine proceeds to step 125 where the document management server 1 transmits to the client A (2), which made the request, the encrypted session ID′.

It should be noted that the process associated with the acquisition of the contents of the document in FIG. 33 is the same as that explained with reference to FIG. 26. However, in the document management server 1 of FIG. 33, since the session ID′ is encrypted in the document management server 1, the encrypted session ID′ is decrypted by using a corresponding key which was used by the document management server to encrypt the session ID′ in the process corresponding to step S101 of FIG. 26.

As shown in FIGS. 33-35, the document management server 1 may processes the session ID based on the request from the client A (2) so as to produce the session ID′. The client B (3), which received the encrypted session ID′ from the client A (2), can use services associated with the documents, which the document management server 1 offers, by using the encrypted session ID′ within a limited right.

It should be noted that although the description was given with reference to the method of acquiring the contents of a document as an example, the document management server 1 can also offer other methods, such as an acquisition method (getprops(session ID′, document ID);) of attribute information of a document or a document storage method (putDocContent(session ID′, document ID);).

Additionally, although the document management server 1 or the client A (2) processes the session ID to produce the session ID′ by adding the document ID of an object to be operated to the session ID in the example mentioned above, the document management server 1 or the client A (2) may process the session ID to produce the session ID′, similar to the above-mentioned examples, by adding an available method.

FIG. 36 is an illustration (part 3) for explaining the session ID′. As shown in FIG. 36, when the original session ID is “5468746165416878746” and a name of an available method (or an identifier of an available method) is “getDocContent,getProps,putDocContent”, the document management server 1 or the client A (2) processes the original session ID so as to produce the session ID′ “5468746165416878746?method-getDocContent,getProps,putDo cContent”. Here, the sign “?” is a separator. In FIG. 36, although the description was given, with reference to FIG. 36, of an example including three methods as methods which are available, this does not limits the scope of the present invention. There may be one or more methods which can be used. Moreover, as explained with reference to FIG. 22, the session ID′ of FIG. 36 may have the XML format.

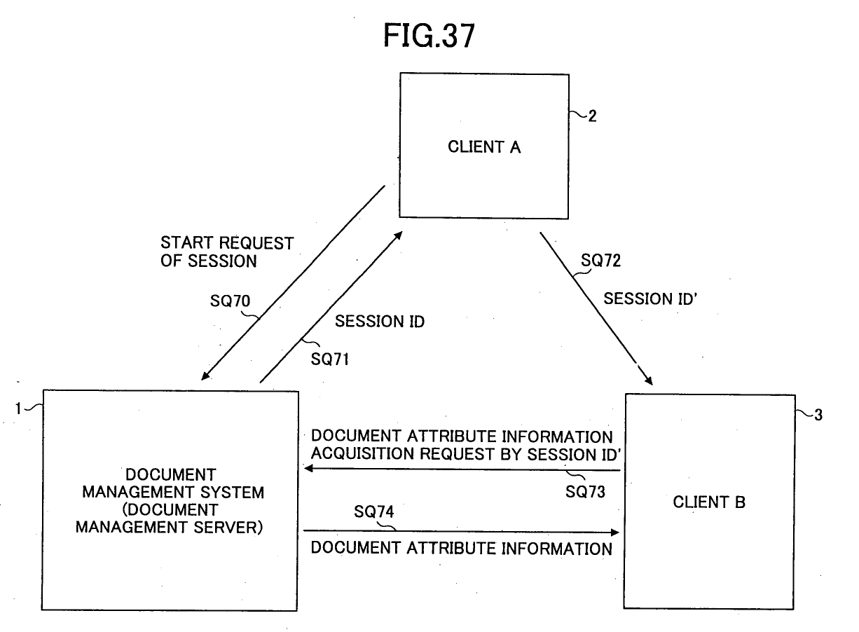

A description will now be given, with reference to FIG. 37, of a process of acquiring attribute information of a document on the assumption the session ID′ shown in FIG. 36 is to be produced. FIG. 37 is an illustration for explaining a process of acquiring attribute information of a document using a processed session ID. The client A (2) transmits a start request of a session containing a user name and a password to the document management server 1 (sequence SQ70). The document management server 1 performs an authentication based on, for example, a user name and a password contained in the start request of a session. When is it a correct combination, the document management server 1 produces a session and transmits a session ID which identifies the session to the client A (2) (sequence SQ71).

The client A (2) adds the name of the method of the object to be operated to the acquired session so as to produce the session ID′ which was explained with reference to FIG. 36. The client A (2) transmits the produced session ID′ to the client B (3) (sequence SQ72).

The client B (3) transmits to the document management server 1 an acquisition request of the attribute information of the document which contains the session ID′ received from the client A (2) (sequence SQ73). The document management server 1 determines validity of the session ID′. When the session ID′ is valid, the document management server 1 acquires the attribute information of the document corresponding to the document ID, and transmits the attribute information to the client B (3) (sequence SQ74).

The client B (3) calls a document attribute information acquisition method, which the document management server 1 offers, in a form of getProps(“5468746165416878746?method=getDocContent, getProps,putDocContent”, “D123543843483456856”);.

It should be noted that the functional structure of the document management server 1 shown in FIG. 37 is the same as the functional structure of the document management server 1 explained in FIG. 19.

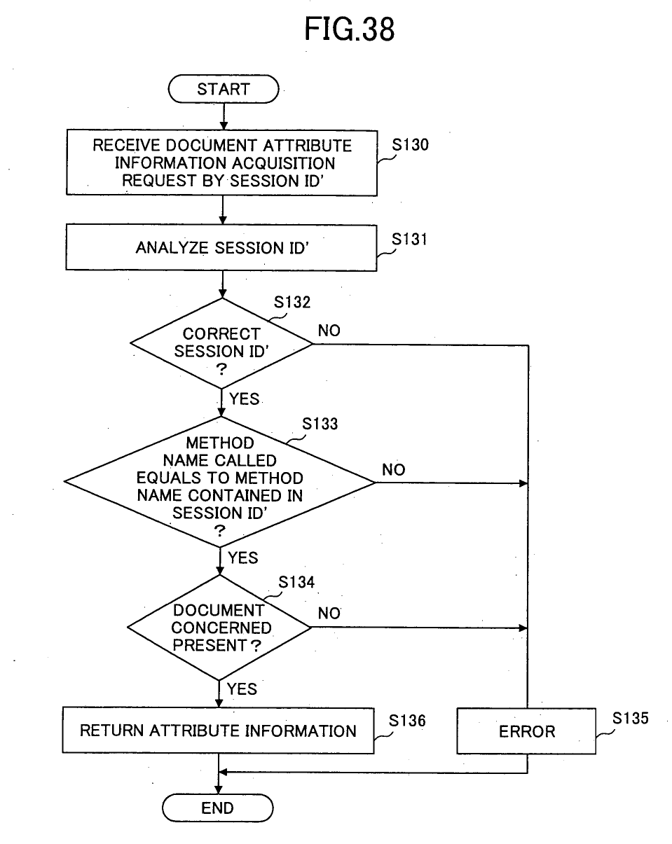

A description will be given below, with reference to FIG. 38, of a process associated with the document attribute information acquisition using the session ID′ in the document management server 1. FIG. 38 is a flowchart for explaining an example of the process associated with the document attribute information acquisition using the session ID′ in the document management server 1.

In step S130, the document management server 1 receives from the client B (3) an acquisition request of the attribute information of the document which contains the session ID′ explained with reference to FIG. 36. Subsequent to step S131, the routine proceeds to step S131 where the document management server 1 analyzes the session ID′ contained in the acquisition request of the attribute information of the document received in step S130, and retrieves the original session ID prior to be processed, the name of the method and the document ID contained in the session ID.

Subsequent to step S131, the routine proceeds to step S132 where the document management server 1 determines whether or not the session ID′ is valid. If it is determined that the session ID′ is valid (YES in step S132), the routine proceeds to step S133. If it is determined that the session ID′ is not valid (NO in step S132), the routine proceeds to step S133. For example, the document management server 1 determines whether or not the session ID′ is valid by checking whether or not the session ID′ is valid based on the original session ID contained in the session ID′ by referring to the session managing means 73, etc.

In step S133, the document management server 1 determines whether the method name contained in the session ID′ and the method name of the called method are the same method name. If it is determined that they are the same method name (YES in step S133), the routine proceeds to step S134. If it is determined that they are not the same method name (NO in step S133), the routine proceeds to step S135. For example, the document management server 1 determines whether or not the method name of the called method (getProps method) is the same as the method name contained in the session ID′ of a first argument of the getProps method mentioned above.

In step S134, the document management server 1 determines whether of not there is a document corresponding to the document ID. If it is determined that the document corresponding to the document ID is present, the routine proceeds to step S136. If it is determined that the document corresponding to the document ID is not present, the routine proceeds to step S135. In step S135, the document management server 1 performs an error process. For example, the document management server 1 produces an error message, and transmits to the client B (3). In step S136, the document management server 1 acquires the attribute information of the document corresponding to the document ID, and transmits the attribution information to the client B (3). As for the attribute information of a document, there are a document name, a preparer of the document, a creation date of the document, etc.

As shown using FIGS. 36-38, the client B (3) can use services associated with the documents offered by the document management server 1 by using the session ID′ within a limited right since the session ID′, which is produced by adding an available method to the session ID, is passed to the client B (3).

It should be noted that the description was given, with reference to FIGS. 37 and 38, of the example in which the client A (2) produces the session ID′ of FIG. 36, the document management server 1 may produce the session ID′ shown in FIG. 36 or may encrypts the produced session ID′ as explained with reference to FIGS. 29-35. Additionally, the client A (2) may encrypt the session ID′ shown in FIG. 36 by a common key or a public key, and encrypted session ID′may be decrypted in the document management server 1, as explained with reference to FIGS. 24-28. Further, the document ID of an object to be operated and an available method may be contained in the session ID′ by combining the structures shown in FIG. 18 and FIG. 36.

As mentioned in the description of the process of the CPU, the present invention is applicable in the form of a service offering program which causes a computer to perform a service offering method (or a process procedure) so that the computer can serve as a service offering apparatus.

Furthermore, the present invention is applicable to a processor readable medium which stores the service offering program according to the present invention. Specifically, as a processor readable medium, there are various recording medium such as a CD-ROM, a magneto-optical disk, a DVD-ROM, a flexible disk (FD), a flash memory, a memory stick or other ROMs or RAMs. The service offering program is recorded on those recording media and provided to a computer (server) so as to cause the computer to perform the service offering method according to the above-mentioned embodiments and variations thereof. Specifically, the above-mentioned recording medium may be attached to the removable disk 46 of the document management server 1 or the service offering program may be stored in the hard disk 43 of the document management server 1 so that the service offering program is read by the CPU, when it is needed, to perform the service offering method according to the present invention.

It should be noted that the clients are also provided with a program, such as a GUI program or a simple browser, necessary to access the document management server 1, and the program is must be executable. Additionally, the service offering program according to the present invention may be installed in an image forming apparatus so that the image forming apparatus can serve as a service offering server mentioned above.

The present invention is not limited to the specifically disclosed embodiments, and variations and modifications may be made without departing from the scope of the present invention.

The present application is based on Japanese priority applications No. 2002-274265 filed Sep. 20, 2002, No. 2003-321074 filed Sep. 12, 2003 and No. 2003-321075 filed Sep. 12, 2003, the entire contents of which are hereby incorporated by reference.

What is claimed is:

1. A service offering apparatus for offering services associated with objects, comprising:
authentication information acquisition request receiving means for receiving an acquisition request for requesting an acquisition of authentication information used for establishing a session having a limited right with respect to said service offering apparatus and said objects;
authentication information transmitting means for transmitting the authentication information; and
session start request receiving means for receiving a start request for requesting a start of the session containing the authentication information from a client different from an end to which the authentication information is transmitted.

2. The service offering apparatus as claimed in claim 1, wherein the acquisition request of the authentication request contains a list of object identifiers for identifying said objects and a list of service identifiers for identifying services associated with said objects.

3. The service offering apparatus as claimed in claim 1, further comprising authentication information producing means for producing the authentication information in response to the acquisition request of the authentication information.

4. The service offering apparatus as claimed in claim 1, further comprising authentication information managing means for managing the authentication information.

5. The service offering apparatus as claimed in claim 4, wherein said authentication information managing means manages the authentication information by relating with the list of the object identifiers for identifying said objects and the list of the service identifiers for identifying the services associated with said objects.

6. The service offering apparatus as claimed in claim 1, further comprising session producing means for producing the session in response to the start request of the session.

7. The service offering apparatus as claimed in claim 1, further comprising session managing means for managing the session.

8. The service offering apparatus as claimed in claim 7, wherein said session managing means manages the session by relating with the authentication information.

9. The service offering apparatus as claimed in claim 1, further comprising session identifier transmitting means for transmitting a session identifier for identifying the session to said client.

10. The service offering apparatus as claimed in claim 1, further comprising use request receiving means for receiving a use request for requesting a use of a service associated with said objects from said client, the use request including a session identifier for identifying the session.

11. The service offering apparatus as claimed in claim 1, further comprising service offering means for offering a service associated with said objects in response to a use request for requesting a use of a service associated with said objects from said client, the use request including a session identifier for identifying the session.

12. The service offering apparatus as claimed in claim 1, wherein the service associated with said objects which is offered in the session is designated.

13. A service offering method for offering services associated with objects, comprising:
an authentication information acquisition request receiving step of receiving an acquisition request for requesting an acquisition of authentication information used for establishing a session having a limited right with respect to said service offering apparatus and said objects;
an authentication information transmitting step of transmitting the authentication information; and
a session start request receiving step of receiving a start request for requesting a start of the session containing the authentication information from a client different from an end to which the authentication information is transmitted.

14. The service offering method as claimed in claim 13, wherein the acquisition request of the authentication request contains a list of object identifiers for identifying said objects and a list of service identifiers for identifying services associated with said objects.

15. The service offering method as claimed in claim 13, further comprising an authentication information producing step of producing the authentication information in response to the acquisition request of the authentication information.

16. The service offering method as claimed in claim 13, further comprising an authentication information managing step of managing the authentication information.

17. The service offering method as claimed in claim 16, wherein said authentication information managing step manages the authentication information by relating with the list of the object identifiers for identifying said objects and the list of the service identifiers for identifying the services associated with said objects.

18. The service offering method as claimed in claim 13, further comprising a session producing step of producing the session in response to the start request of the session.

19. The service offering method as claimed in claim 13, further comprising a session managing step of managing the session.

20. The service offering method as claimed in claim 19, wherein said session managing step manages the session by relating with the authentication information.

21. The service offering method as claimed in claim 13, further comprising a session identifier transmitting step of transmitting a session identifier for identifying the session to said client.

22. The service offering method as claimed in claim 13, further comprising a use request receiving step of receiving a use request for requesting a use of a service associated with said objects from said client, the use request including a session identifier for identifying the session.

23. The service offering method as claimed in claim 13, further comprising a service offering step of offering a service associated with said objects in response to a use request for requesting a use of a service associated with said objects from said client, the use request including a session identifier for identifying the session.

24. The service offering method as claimed in claim 13, wherein the service associated with said objects which is offered in the session is designated.

25. A processor readable medium storing a service offering program for causing a computer to execute a service offering method for offering services associated with objects, the service offering method comprising:
an authentication information acquisition request receiving step of receiving an acquisition request for requesting an acquisition of authentication information used for establishing a session having a limited right with respect to said service offering apparatus and said objects;
an authentication information transmitting step of transmitting the authentication information; and
a session start request receiving step of receiving a start request for requesting a start of the session containing the authentication information from a client different from an end to which the authentication information is transmitted.

26. The processor readable medium as claimed in claim 25, wherein the acquisition request of the authentication request contains a list of object identifiers for identifying said objects and a list of service identifiers for identifying services associated with said objects.

27. The processor readable medium as claimed in claim 25, wherein the service offering method further comprises an authentication information producing step of producing the authentication information in response to the acquisition request of the authentication information.

28. The processor readable medium as claimed in claim 25, wherein the service offering method further comprises an authentication information managing step of managing the authentication information.

29. The processor readable medium as claimed in claim 28, wherein said authentication information managing step manages the authentication information by relating with the list of the object identifiers for identifying said objects and the list of the service identifiers for identifying the services associated with said objects.

30. The processor readable medium as claimed in claim 25, wherein the service offering method further comprises a session producing step of producing the session in response to the start request of the session.

31. The processor readable medium as claimed in claim 25, wherein the service offering method further comprises a session managing step of managing the session.

32. The processor readable medium as claimed in claim 31, wherein said session managing step manages the session by relating with the authentication information.

33. The processor readable medium as claimed in claim 25, wherein the service offering method further comprises a session identifier transmitting step of transmitting a session identifier for identifying the session to said client.

34. The processor readable medium as claimed in claim 25, wherein the service offering method further comprises a use request receiving step of receiving a use request for requesting a use of a service associated with said objects from said client, the use request including a session identifier for identifying the session.

35. The processor readable medium as claimed in claim 25, wherein the service offering method further comprises a service offering step of offering a service associated with said objects in response to a use request for requesting a use of a service associated with said objects from said client, the use request including a session identifier for identifying the session.

36. The processor readable medium as claimed in claim 25, wherein the service associated with said objects which is offered in the session is designated.

37. A service offering program for causing a computer to execute a service offering method for offering services associated with objects, the service offering method comprising:
an authentication information acquisition request receiving step of receiving an acquisition request for requesting an acquisition of authentication information used for establishing a session having a limited right with respect to said service offering apparatus and said objects;
an authentication information transmitting step of transmitting the authentication information; and
a session start request receiving step of receiving a start request for requesting a star of the session containing the authentication information from a client different from an end to which the authentication information is transmitted.

38. The service offering program as claimed in claim 37, wherein the acquisition request of the authentication request contains a list of object identifiers for identifying said objects and a list of service identifiers for identifying services associated with said objects.

39. The service offering program as claimed in claim 37, wherein the service offering method further comprises an authentication information producing step of producing the authentication information in response to the acquisition request of the authentication information.

40. The service offering program as claimed in claim 37, wherein the service offering method further comprises an authentication information managing step of managing the authentication information.

41. The service offering program as claimed in claim 40, wherein said authentication information managing step manages the authentication information by relating with the list of the object identifiers for identifying said objects and the list of the service identifiers for identifying the services associated with said objects.

42. The service offering program as claimed in claim 37, wherein the service offering method further comprises a session producing step of producing the session in response to the start request of the session.

43. The service offering program as claimed in claim 37, wherein the service offering method further comprises a session managing step of managing the session.

44. The service offering program as claimed in claim 43, wherein said session managing step manages the session by relating with the authentication information.

45. The service offering program as claimed in claim 37, wherein the service offering method further comprises a session identifier transmitting step of transmitting a session identifier for identifying the session to said client.

46. The service offering program as claimed in claim 37, wherein the service offering method further comprises a use request receiving step of receiving a use request for requesting a use of a service associated with said objects from said client, the use request including a session identifier for identifying the session.

47. The service offering program as claimed in claim 37, wherein the service offering method further comprises a service offering step of offering a service associated with said objects in response to a use request for requesting a use of a service associated with said objects from said client, the use request including a session identifier for identifying the session.

48. The service offering program as claimed in claim 37, wherein the service associated with said objects which is offered in the session is designated.

49. A service offering apparatus for offering services associated with objects, comprising:
session start request receiving means for receiving a start request for requesting a start of a session with the service offering apparatus;
session identifier transmitting means for transmitting a session identifier for identifying the session; and
use request receiving means for receiving a use request for requesting a use of a service associated with said objects from a client different from an end to which the session identifier is transmitted, the use request including information regarding the session identifier.

50. The service offering apparatus as claimed in claim 49, further comprising session producing means for producing the session in response to the start request of the session.

51. The service offering apparatus as claimed in claim 49, further comprising session managing means for managing the session.

52. The service offering apparatus as claimed in claim 49, further comprising service offering means for offering the service associated with said objects in response to use request of the service associated with said objects, the use request containing the information regarding the session identifier.

53. The service offering apparatus as claimed in claim 49, wherein the information regarding the session identifier includes the session identifier and an object identifier for identifying said objects.

54. The service offering apparatus as claimed in claim 49, wherein the information regarding the session identifier includes the session identifier and a service identifier for identifying a service associated with said objects.

55. The service offering apparatus as claimed in claim 49, wherein the information regarding the session identifier is encrypted by a public key.

56. The service offering apparatus as claimed in claim 49, further comprising public key providing means for providing a public key in response to an acquisition request for requesting an acquisition of the public key.

57. The service offering apparatus as claimed in claim 49, wherein the information regarding the session identifier is encrypted by a common key common to the service offering apparatus.

58. The service offering apparatus as claimed in claim 49, further comprising session identifier processing means for processing the session identifier.

59. The service offering apparatus as claimed in claim 58, further comprising encrypting means for encrypting the session identifier processed by said session identifier processing means.

60. A service offering method for offering services associated with objects, comprising:
a step of receiving a start request for requesting a start of a session with the service offering apparatus;
a step of transmitting a session identifier for identifying the session; and
a step of receiving a use request for requesting a use of a service associated with said objects from a client different from an end to which the session identifier is transmitted, the use request including information regarding the session identifier.

61. The service offering method as claimed in claim 60, further comprising a step of producing the session in response to the start request of the session.

62. The service offering method as claimed in claim 60, further comprising a step of managing the session.

63. The service offering method as claimed in claim 60, further comprising a step of offering the service associated with said objects in response to use request of the service associated with said objects, the use request containing the information regarding the session identifier.

64. The service offering method as claimed in claim 60, wherein the information regarding the session identifier includes the session identifier and an object identifier for identifying said objects.

65. The service offering method as claimed in claim 60, wherein the information regarding the session identifier includes the session identifier and a service identifier for identifying a service associated with said objects.

66. The service offering method as claimed in claim 60, wherein the information regarding the session identifier is encrypted by a public key.

67. The service offering method as claimed in claim 60, further comprising a step of providing a public key in response to an acquisition request for requesting an acquisition of the public key.

68. The service offering method as claimed in claim 60, wherein the information regarding the session identifier is encrypted by a common key common to the service offering apparatus.

69. The service offering method as claimed in claim 60, further comprising a step of processing the session identifier.

70. The service offering method as claimed in claim 69, further comprising a step of encrypting the session identifier processed by said session identifier processing means.

71. A processor readable medium storing a service offering program for causing a computer to execute a service offering method for offering services associated with objects, the service offering method comprising:
a step of receiving a start request for requesting a start of a session with the service offering apparatus;
a step of transmitting a session identifier for identifying the session; and
a step of receiving a use request for requesting a use of a service associated with said objects from a client different from an end to which the session identifier is transmitted, the use request including information regarding the session identifier.

72. The processor readable medium as claimed in claim 71, wherein the service offering method further comprises a step of producing the session in response to the start request of the session.

73. The processor readable medium as claimed in claim 71, wherein the service offering method further comprises a step of managing the session.

74. The processor readable medium as claimed in claim 71, wherein the service offering method further comprises a step of offering the service associated with said objects in response to use request of the service associated with said objects, the use request containing the information regarding the session identifier.

75. The processor readable medium as claimed in claim 71, wherein the information regarding the session identifier includes the session identifier and an object identifier for identifying said objects.

76. The processor readable medium as claimed in claim 71, wherein the information regarding the session identifier includes the session identifier and a service identifier for identifying a service associated with said objects.

77. The processor readable medium as claimed in claim 71, wherein the information regarding the session identifier is encrypted by a public key.

78. The processor readable medium as claimed in claim 71, the service offering method further comprises a step of providing a public key in response to an acquisition request for requesting an acquisition of the public key.

79. The processor readable medium as claimed in claim 71, wherein the information regarding the session identifier is encrypted by a common key common to the service offering apparatus.

80. The processor readable medium as claimed in claim 71, wherein the service offering method further comprises a step of processing the session identifier.

81. The processor readable medium as claimed in claim 80, wherein the service offering method further comprises a step of encrypting the session identifier processed by said session identifier processing means.

82. A service offering program for causing a computer to execute a service offering method for offering services associated with objects, the service offering method comprising:
a step of receiving a start request for requesting a start of a session with the service offering apparatus;
a step of transmitting a session identifier for identifying the session; and
a step of receiving a use request for requesting a use of a service associated with said objects from a client different from an end to which the session identifier is transmitted, the use request including information regarding the session identifier.

83. The service offering program as claimed in claim 82, wherein the service offering method further comprises a step of producing the session in response to the start request of the session.

84. The service offering program as claimed in claim 82, wherein the service offering method further comprises a step of managing the session.

85. The service offering program as claimed in claim 82, wherein the service offering method further comprises a step of offering the service associated with said objects in response to use request of the service associated with said objects, the use request containing the information regarding the session identifier.

86. The service offering program as claimed in claim 82, wherein the information regarding the session identifier includes the session identifier and an object identifier for identifying said objects.

87. The service offering program as claimed in claim 82, wherein the information regarding the session identifier includes the session identifier and a service identifier for identifying a service associated with said objects.

88. The service offering program as claimed in claim 82, wherein the information regarding the session identifier is encrypted by a public key.

89. The service offering program as claimed in claim 82, the service offering method further comprises a step of providing a public key in response to an acquisition request for requesting an acquisition of the public key.

90. The service offering program as claimed in claim 82, wherein the information regarding the session identifier is encrypted by a common key common to the service offering apparatus.

91. The service offering program as claimed in claim 82, wherein the service offering method further comprises a step of processing the session identifier.

92. The service offering program as claimed in claim 91, wherein the service offering method further comprises a step of encrypting the session identifier processed by said session identifier processing means.
